(19) United States
(12) Patent Application Publication
(10) Pub. No.: US 2021/0344771 A1
(43) Pub. Date: Nov. 4, 2021

(54) System and Method for Cloud Computing

(71) Applicants: Brendon P. Cassidy, Venice, CA (US); Justin R. Weiler, Fullerton, CA (US)

(72) Inventors: Brendon P. Cassidy, Venice, CA (US); Justin R. Weiler, Fullerton, CA (US)

(21) Appl. No.: 13/351,813

(22) Filed: Jan. 17, 2012

Related U.S. Application Data
(60) Provisional application No. 61/433,515, filed on Jan. 17, 2011.

(51) Int. Cl. H04L 29/08

(52) U.S. Cl. CPC H04L 67/2838; H04L 67/1031; H04L 67/1008

(57) ABSTRACT

A system for computing is provided that includes a plurality of inter-connected processing systems for processing data. Each processing system includes a mapping system, wherein the mapping system generates a key based on the data, the key identifying at least one target processing system from the plurality of inter-connected processing systems. A processing system further includes a synchronization system that maintains the availability of the plurality of inter-connected processing systems. Also included is an execution system configured to respond to an action request on data from the a plurality of inter-connected processing systems, wherein the execution system operates on the data to produce a result and responds to the action request with the result, and a request system for sending the action request.

### CROSS REFERENCE TO RELATED APPLICATIONS

This application claims priority to U.S. Provisional Patent Application No. 61/433,515 filed on Jan. 17, 2011, titled “SYSTEM AND METHOD FOR CLOUD COMPUTING”, to Brendon P. Cassidy et al., all of which is incorporated herein by reference.

### FIELD

The present application is related to a system for administering distributed computing.

### BACKGROUND

Traditional large-scale computing applications involve dedicated server models at datacenters. A move to cloud computing introduces the ability to scale and model the computing applications with a highly flexible and configurable manner. Cloud computing may be interpreted as utilization of one or more third-party servers to receive services over a network (e.g., the internet or a local area network (“LAN”)). Typical services may include software applications, cache operations, file storage, etc.

A cloud computing system may utilize one or more physical computers that may be located at a central location (e.g., a datacenter) or at disparate locations (e.g., datacenters or other locations housing computers such as business sites). Typical cloud computing systems may use a large number of servers that may be used for a single business goal, or they may be used as commodity servers to provide services for any number of business goals or applications for end-users.

In general, the cloud computing system may provide similar functionality to a typical desktop or local computing system, such as processing, file storage, and providing for application use. However, some or all of this functionality may be provided from the cloud, rather than locally.

Typical current cloud-based systems may include email (i.e., web-based email) and software-as-a-service. However, numerous other advantages may be achieved through scalability, the lack of software and hardware management for businesses, and the ability to modify the cloud for a particular need or during peak-utilization.

Thus, there exists a need for highly scalable computing power with the ability to persist state across the system, as well as provide redundant content/data storage. Moreover, there is a need for a cloud computing environment that may allow for optimization of resources that may take into account the type of applications used, as well as machine-level information and resources.

### BRIEF DESCRIPTION OF THE DRAWINGS

The present invention will now be described, by way of example, with reference to the accompanying drawings, in which:

FIG. 1 shows an example of a system for cloud computing.

FIG. 1A shows an example of a system for cloud computing utilizing a hosted environment and a self-maintained environment.

FIG. 2 shows a client accessing cloud using cloud proxies.

FIG. 3 shows an example of a UDP multicast strategy for identifying and determining the status of each proxy.

FIG. 4 shows an example of a centralized proxy.

FIG. 5 shows a request from a cloud proxy to the cloud.

FIG. 6 is an example of a multi-dimension keymap.

FIG. 7 is an example of a keymap having four (4) machines indicated on the vertical axis.

FIG. 8 is an example of a keymap where four (4) machines are used.

FIG. 9 is an example of a mapping of “user preferences” to a keymap.

FIG. 10 is an example of a mapping of “user favorites” to a keymap.

FIG. 11 is an example of a mapping of “user data” to a keymap.

FIG. 12 is an example of a keymapping of “user preferences”.

FIG. 13 is an example of a PUT function using a keymap.

FIG. 14 shows an example of an output for a hash function.

FIG. 15 is an example of a method for using a hash function to create a keymap distribution.

FIG. 16 shows a cloud-based cache system.

FIG. 17 shows a cloud-based file system.

FIG. 18 shows a cloud-based queue and keymap.

FIG. 19 shows a cloud-based database and keymap.

FIG. 20 is an example of cloud client service instances and cloud proxy instances on machine.

FIG. 21 is an example of a cloud health management system.

FIG. 22 is an example of a granular cloud health management system.

FIG. 23 is an example of a performance analysis system.

FIG. 24 is an example of a self-healing system.

FIG. 25 is an example of a self-tuning system.

FIG. 26 is an example of a cloud security protocol system.

FIG. 27 is an example of a cloud audit system.

FIG. 28 is an example of a cloud power management system.

FIG. 29 is an example of a cloud management and deployment system.

FIG. 30 is an example of the cloud computing architecture.

FIG. 31A is an example of a simplified replicated keymap.

FIG. 31B is an example of a cloud instance identifying a location for a context and a key.

FIG. 31C is an alternative example of a cloud instance identifying a location for a context and a key.

FIG. 32 is an example of routing and data aggregation using proxies.

FIG. 33 is an example of a cartographer distribution of a keymap related to cloud instances.

FIG. 34 is an example of a system utilizing the cloud system having separate cloud groups for specific functions.

FIG. 34A is an example of the keymap for the catalog search.

FIG. 34B is an example of the keymap for the user search.

FIG. 34C is an example of the keymap for the user information.

FIG. 34D is an example of an alternative keymap for the user information.

FIG. 35 is an example of the keymap for the catalog.

FIG. 36 is an example of a system utilizing the cloud system having shared cloud groups for specific functions.

FIG. 37 shows an example keymap for a catalog search group having shared cloud groups.

FIG. 38 shows an example keymap for a user search group having shared cloud groups.

FIG. 39 is an example of a file system add-in for use with the system for cloud computing.

FIG. 40 is an example of the file system having access to local machine resources.

FIG. 41 is an example of two file system blocks having data before reallocating data to a third file system block.

FIG. 42 is an example of an efficient data transfer based on a keymap update.

FIG. 43 is an example of an alternative data transfer scheme based on a keymap update.

FIG. 44 is an example of data transfer based on a keymap update.

FIG. 45 is an example of an update sequence when a keymap update and data transfer is underway.

FIG. 46 is an example sequence diagram of the data transfer when a keymap update is underway.

FIG. 47 is an example of a flow diagram for updating a keymap using a workorder.

FIG. 48 is an example of a state diagram for requesting a file using the file system.

FIG. 49 is an example of a state diagram for writing a file using the file system.

FIGS. 50-84 are examples of a cloud computing administrator system.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an embodiment. Further, the embodiments described herein are not intended to be exhaustive or otherwise limit or restrict the invention to the precise form and configuration shown in the drawings and disclosed in the following detailed description.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, C#, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

In general, the cloud computing system may be used for a wide variety of implementations. Some large scale implementations may include a large search engine, an auto-complete for a search engine (e.g., auto-suggest/auto-complete), a recommender based on previous choices and/or purchases, data analysis and reporting, as well as media file encoding.

The cloud computing system may be operated on a server farm (machines in your own datacenter), on hosted machines/cloud, a local area network of machines, or any combination thereof. This allows the cloud computing system to be operated and controlled in one's own environment or partially or wholly in an environment provided by another. In general, the cloud computing system provides a framework that can be operated on any variety of machine configurations and networks. Moreover, the framework allows platforms to share memory, processing and disk resources locally, across networks, and across managed services or hardware in the developer's datacenter.

The cloud computing system also allows a user to write plug-in modules (e.g., add-ins) to take advantage of the cloud computing framework. These plug-in modules, or add-ins, may include workflows, applications, storage solutions, and other specialized software. Additionally, the framework allows for a variety of operating systems to be used, such as Microsoft® operating systems, varieties of Unix/Linux, Sun, etc. When using a Microsoft® .Net based cloud computing system, the framework can be operated on Linux-style operating systems using Mono (i.e., an open source development platform based on the .NET framework and .NET implementation using the Common Language Infrastructure).

Other examples of cloud-based computing applications include, generally, distributed data and distributed work functionality. Massive content management system with large data sets, business intelligence and data mining consumer data, signal processing, modeling and simulation such as protein folding or multi-body and fluid analysis, pattern recognition for securities trading, gene sequencing applications, or mass rendering of 3-D animations. While the list of applications provided is intended to describe the wide variety of applications a cloud computing system may be used for, it is not intended to limit the applications to those mentioned since the cloud computing system may be configured and used in applications in any useful manner.

As discussed herein, the cloud computing system is a general term used to describe a distributed computing system having more than one instance of the computing system (e.g., a cloud element) that are communicatively connected by a network. They may be inter-connected via a one to one arrangement, they may be inter-connected disparately by a series of LAN and/or wide area network (“WAN”) connections, or they may be inter-connected within a local machine, or a combination thereof. Typical local machine assets may use non-network-based communication for inter-connection and may also be available for inter-process communication to avoid traditional networking protocols (e.g., TCP/IP, etc.). However, in some cases the inter-connected cloud elements may use network protocol within the local machine but may not have certain network communication outside the local machine (e.g., messages may not be sent over the wire outside the local machine).

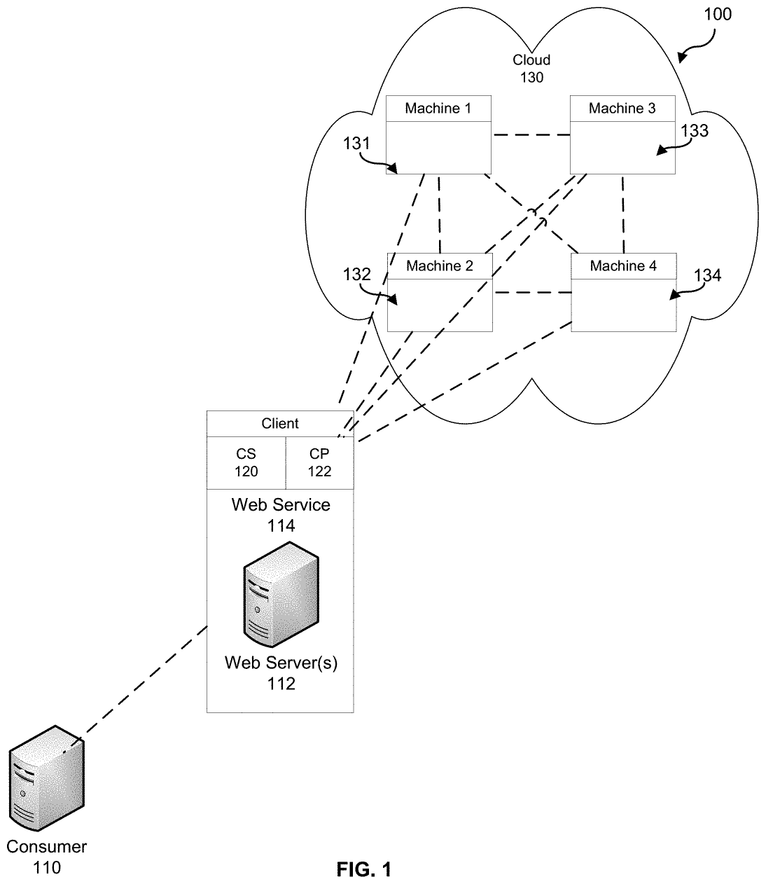

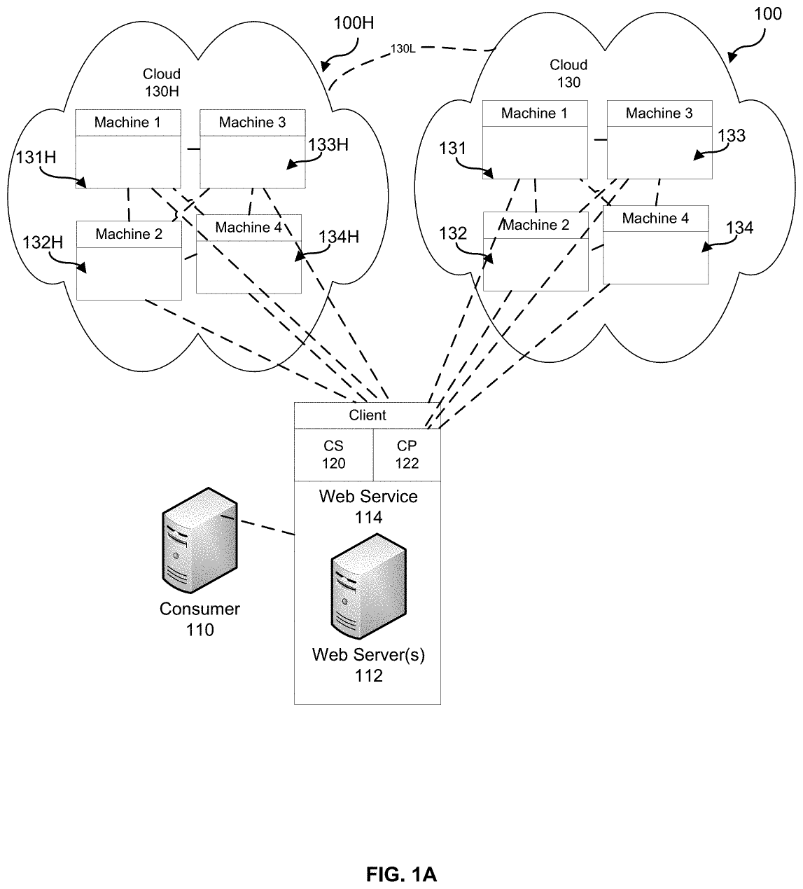

FIG. 1 shows an example of a system for cloud computing 100. The system 100 may include a consumer 110, web server(s) 112, a cloud client service (“CS”) 120, a cloud proxy (“CP”) 122, the cloud 130 and multiple cloud machines 131-134. The cloud system 110 may provide for multiple consumers 110, web servers 112 and many cloud machines 131-134 within the cloud that may be modified while the cloud is in operation. The cloud machines 131-134 may be within a hosted environment and/or a self-maintained environment (e.g., your datacenter). The system for cloud computing provides a framework for allowing the machines to essentially be located anywhere and managed by anyone.

A consumer 110 of the cloud's services may be a networked computer or computers. However, the consumer 110 may also include other cloud-based systems, mobile systems, and hybrid systems. The consumer 110, as described herein for simplicity, may be a typical end-user machine that could be a personal computer, or in business applications, multiple client computers or mainframe systems.

In general, a typical application includes a web server 112 interface to the cloud such that requests for services are received at a predetermined front-end, and then the services are handled transparently within the cloud. As described herein, a single web-server 112 may be shown in the drawings as a front-end to the cloud. However, many web-servers 112 may be used to access the cloud directly at the same time, for example, where redundancy and/or reducing latency is desirable.

Where web server 112 is used to access the cloud, it may be provided with a cloud client service 120 and/or a cloud proxy 122 to access the cloud system 130 directly. The cloud client service 120 may include part or all of the functionality of the cloud machines 131-134 within the cloud 130. The cloud proxy 122 may be used as the network communication layer to access the cloud's functionality.

Alternatively, consumers 110 may be provided with software such as cloud client service 120 and/or a cloud proxy 122 to access the cloud 130 directly. This type of direct access system may be desirable, for example, where each user is authenticated and is trusted with access to the cloud system 130.

Cloud machines 131-134 may be configured for use within the cloud for a particular job, or they may be similarly configured for consistency of hardware. For example, where a machine will be used more for data storage than for CPU utilization, the data storage capacity may be increased and where a machine is used for CPU utilization, the speed or number of cores may be increased. However, when machine consistency is desired (e.g., for maintenance, purchase or simplified swapping or replacement purposes), then each machine may be configured with the same or substantially the same hardware.

FIG. 1A shows an example of a system for cloud computing utilizing a hosted environment 130H and a self-maintained environment 130. The system for cloud computing also provides a framework for using managed services (e.g., cloud-based computing resources from providers such as Amazon, Rackspace, etc.) to interoperate with the cloud without regard to the managed resource itself. This allows for high scalability and simplified changes of vendors based on economics. For example, if resources are under stress on your own self-maintained environment (e.g., your datacenter equipment), then additional resources such as storage, processing, and memory may be added by a generic vendor that provides these services. Moreover, addition of capacity may be done without regard to the vendor. For example, if one vendor provides superior processing capability, they may be chosen over one that provides superior storage capability, based on the economics of how much will be process, stored, memory used, and network traffic expected. Communication may exist from the outside client, or between sub-clouds 130L that allows the clouds 130 and 130H to operate as one cloud. The ability to create a cloud that uses self-maintained and hosted environments (and if desired, multiple hosted environments) also provides for high levels of redundancy and failure recovery. When multiple hosted environments are used, the economic conditions and cost for each may be weighed and the cloud may be optimized for cost and performance at predetermined intervals or upon events (e.g., when hosted environment prices change).

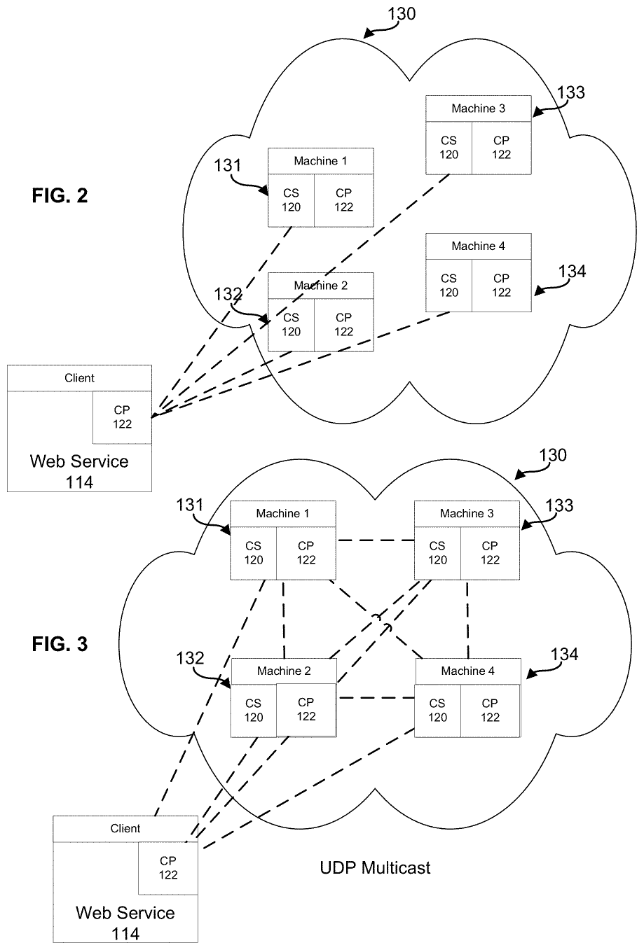

FIG. 2 shows a client accessing cloud 130 using cloud proxies 122. The cloud proxy 122 used by web service 114 communicates with cloud services 120 of machines 131-134. The cloud proxies 122 may use a variety of communication mechanisms to discover each other. In this example, cloud proxy 122 is communicating via network with cloud services 120 related to machines 131-134. In an example, each proxy 122 may use an ad-hoc method or centralized proxy to determine the network addresses (or the like) of each other. Cloud proxies 122 generally communicate with cloud services 120 but may on occasion communicate with other cloud proxies 122. When services 122 need to communicate with other services 122, they may use their local cloud proxy 122 which in turn communicates with the appropriate cloud service 120.

In an example where the cloud 130 utilizes the Microsoft .Net platform, each cloud proxy 122 may use Windows Communication Foundation (“WCF”) endpoints to locate and communicate with each other. The endpoint may comprise an address indicating where the endpoint is located, a binding specifying how a client may communicate with the endpoint, a contract that identifies the operations available at the endpoint, and behaviors that determine the local operation of the endpoint. As will be understood by one of skill in the art, a .Net WCF implementation is only one of many implementations that may be used, including but not limited to, Java Web Services (Java WS), SOAP (sometimes called Simple Object Access Protocol), and “Plain Old XML” (PDX).

FIG. 3 shows an example of a UDP multicast strategy for identifying and determining the status of each proxy 122. In an ad-hoc discovery system, each cloud proxy 122 may send a broadcast message, UDP multicast message, or other multicast to send messages to the other cloud proxies 122. For example, when a machine 131-134 comes “on line”, it may send a UDP multicast on the network with a message that it wishes to join the cloud 130. Similarly, if a machine is going “off line”, it may send a UDP multicast message indicating that it is removing itself from the cloud 130.

Additionally, the UDP multicast system may be used to determine the health of a machine. For example, a “heartbeat” signal, such as a periodic UDP multicast transmission may be tracked by other cloud proxies 122 to determine the health of the machine and its related cloud proxy 122 and/or cloud service 120. For example, a cloud proxy 122 may include a 1 minute timeout on the UDP multicast “heartbeat” for cloud proxies 122 and/or cloud services 120 being tracked. If a “heartbeat” message is not received from a machine in the predetermined time interval that machine is treated as being offline until another heartbeat comes in verifying its availability.

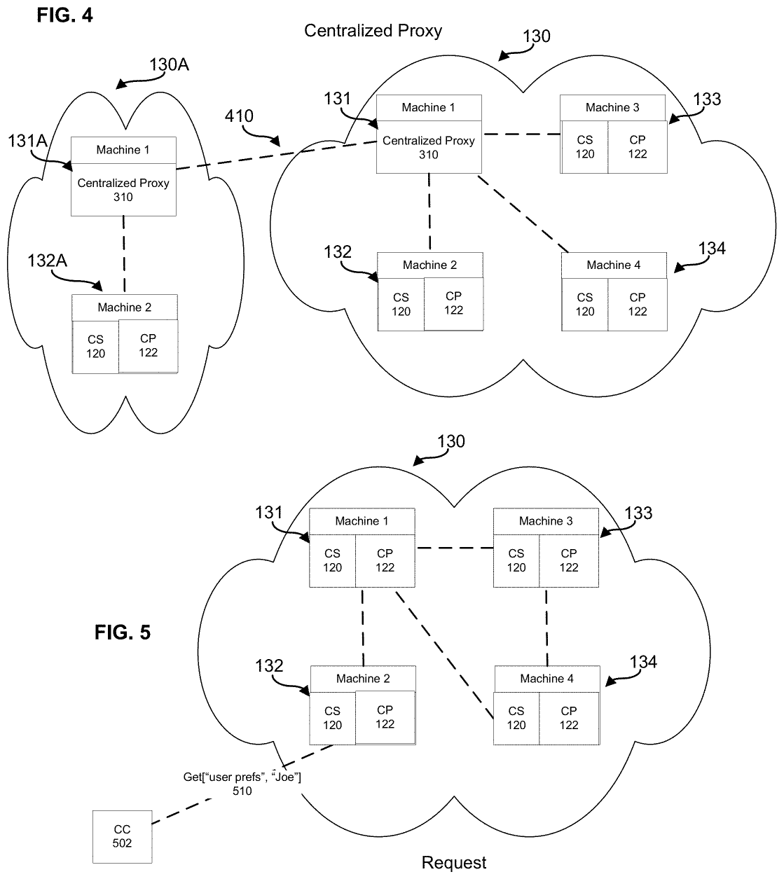

FIG. 4 shows an example of a centralized proxy 310. Centralized proxy 310 may be considered a surrogate or bridge into another network. In this way, centralized proxy 310 may be considered a specialized gateway that may connect two or more isolated cloud instances over another network connection 410. For example, network connection 410 may be configured as a secured VPN or an unsecured network (e.g., the Internet). Cloud proxy 310 may also be configured as a full member of cloud 130. The other cloud proxies 122 may then query the centralized proxy 310. It is understood that the proxy systems may include more than one centralized proxy 310 that may allow the cloud 130 to span across networks, including a WAN such as the Internet. Alternatively, cloud 130 may span across networks using equipment such as a VPN to connect disparate or decentralized locations via a common network. As shown, cloud 130 communicates via network connection 410 with another cloud instance 130A, which includes a centralized proxy 131A and machine 132A. In this way, multiple cloud instances may be joined.

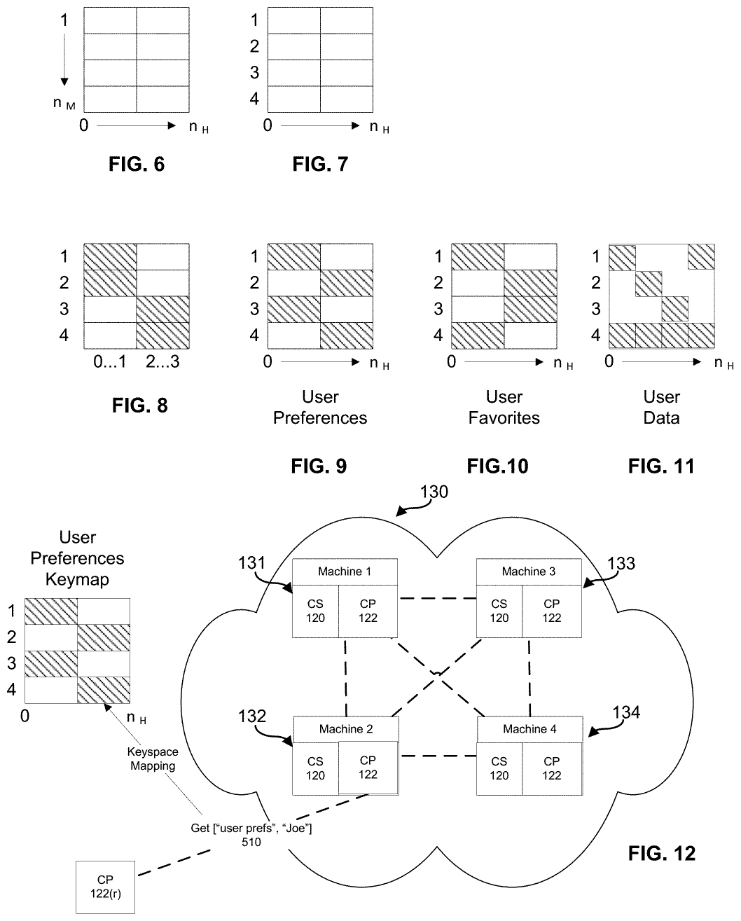

FIG. 5 shows a request 510 from a cloud proxy 122(r) to the cloud 130. The request 510 may be modeled after Representational State Transfer (“REST”) that may include actions such as “GET”, “POST”, “PUT”, and “DELETE”, as one of skill in the art will appreciate. In this example, request 510 is a “GET” action where the data being sought is for user preferences (e.g., “user prefs”) and the particular user is identified as “Joe”. The cloud proxy 510 makes a request to the cloud 130 and the data will be returned. However, the cloud proxy 122(r) may need to know which machine 131-134, or which cloud proxy 122 holds the data. As explained in FIGS. 6-15, a keymapping strategy may be employed by each cloud proxy 122 to determine which machine 131-134 to make the request based on (in this example) the user preferences and the particular user.

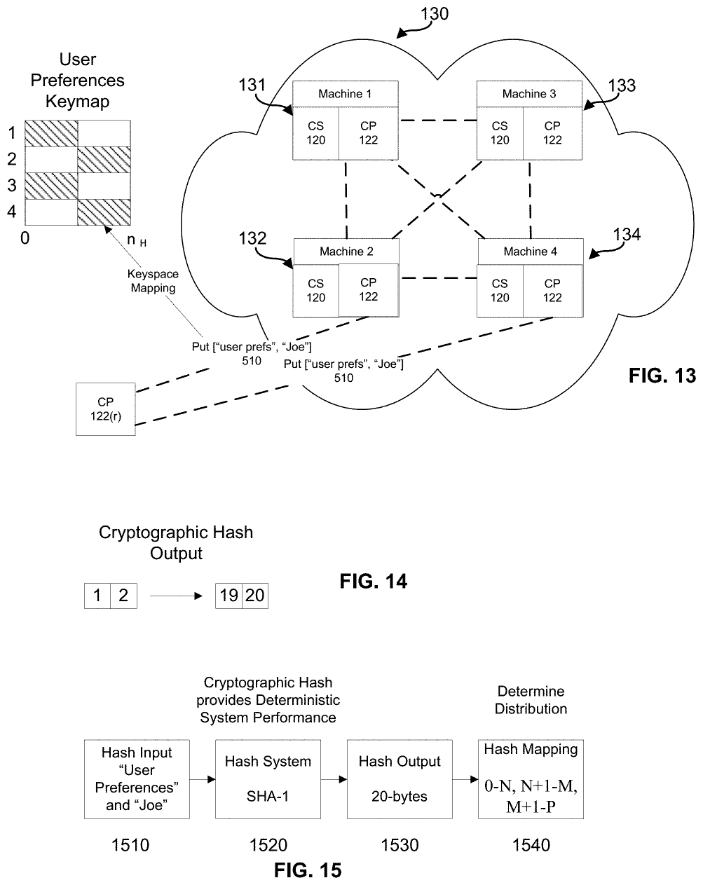

FIG. 6 is an example of a multi-dimension keymap. The vertical axis may represent the machines (physical or virtual) that are assigned to the cloud 130. The horizontal axis represents a hash function output (explained in more detail with respect to FIGS. 13-14) which is the keyspace. When an input (such as the request for “user prefs”, “Joe” as shown in FIG. 5) is assigned a hash key, the keymap is used to determine which machines to communicate with related to that information.

The keymap may also be divided or assigned based on many factors, including the cost (e.g., execution time) of the task vs. the capability of the machine. Moreover, there may be optimization of the keymap based on various parameters including CPU speed and number of cores, the amount of RAM in the machine, and the amount of persistent storage available on the machine. If, for example, a machine configuration changes, the keymap may also be changed to reflect the performance of the new machine.

FIG. 7 is an example of a keymap having four (4) machines indicated on the vertical axis.

FIG. 8 is an example of a keymap where four (4) machines are used and the keyspace is zero (0) to three (3). Keyspace values 0 . . . 1 are assigned to machines 1 . . . 2, and keyspace values 2 . . . 3 are assigned to machines 3 . . . 4.

FIG. 9 is an example of a mapping of “user preferences” to a keymap. The size of the keyspace is 0 . . . n(H) where n(H) represents the size of the hash function output (see FIGS. 13-14). In this example, the first part of the keyspace is assigned to machines 1 and 3, whereas the second part of the keyspace is assigned to machines 2 and 4.

FIG. 10 is an example of a mapping of “user favorites” to a keymap. The size of the keyspace is 0 . . . n(H) where n(H) represents the size of the hash function output (see FIGS. 13-14). In this example, the first part of the keyspace is assigned to machines 1 and 4, whereas the second part of the keyspace is assigned to machines 2 and 3. The output of the keymap, based on the input, is the target processing system. For example, when the key corresponds to the first part of the keyspace, the target processing systems are machines 1 and 4. When the key corresponds to the second part of the keyspace the target processing systems are machines 2 and 3. Although as shown here there is redundancy for all keys, the system may also provide a single target processing system for a given key, based on configuration.

FIG. 11 is an example of a mapping of “user data” to a keymap. The size of the keyspace is 0 . . . n(H), the n(H) representing the size of the hash function output (see FIGS. 13-14). In this example, the first quarter of the keyspace is assigned to machines 1 and 4, the second quarter of the keyspace is assigned to machines 2 and 4, the third quarter of the keyspace is assigned to machines 3 and 4, and the fourth quarter of the keyspace is assigned to machines 1 and 4.

Although not shown with every possible combination, as is shown through the examples of FIGS. 8-11, the keymapping of keyspace to machines may be done with any configuration. This mapping may be used, for example, to provide redundancy, or mapping to machines for other criteria such as computing power (e.g., CPU availability), geographical location, and other factors.

FIG. 12 is an example of a keymapping of “user prefs” with the value of “Joe” and an associated “GET” function for the data. Cloud proxy 112(r) includes a copy of the keymap (also shown in FIG. 12) that has a keyspace mapping on the upper half of the keyspace (see arrow with keyspace mapping). Thus, the cloud proxy 112(r) may choose between two (2) redundant machines, identified as “machine 2” (shown at arrow 132) and “machine 4” (shown at arrow 134) to get the data from. Machine 2 and Machine 4 are fungible with respect to the keymapped data and the two machines are used for redundancy in the event that one of the machines is removed from the cloud 130, or has a fault. The cloud proxy 112(r) may use an alternating strategy for deciding which machine to retrieve the information from. In this example, cloud proxy 112(r) decides to use machine 2 to retrieve the data from. Thus, the proxy has the endpoint of machine 2's cloud proxy 112 and communicates the GET command to it.

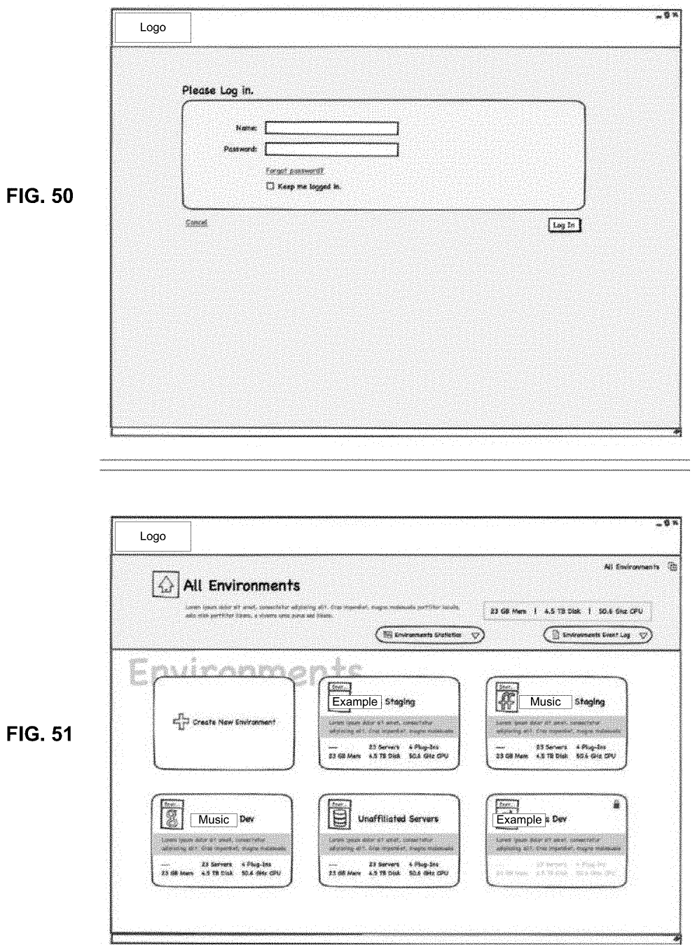

In the event that machine 2 does not respond, cloud proxy 112(r) may resend the GET command to the other keymapped machine; machine 4. Cloud proxy 112(r) may also register a log event or machine failure with the cloud management system (see FIGS. 50-84). Such a redirection of the GET command is an example of a consistency system that maintains that the information retrieved is the same, or correct.

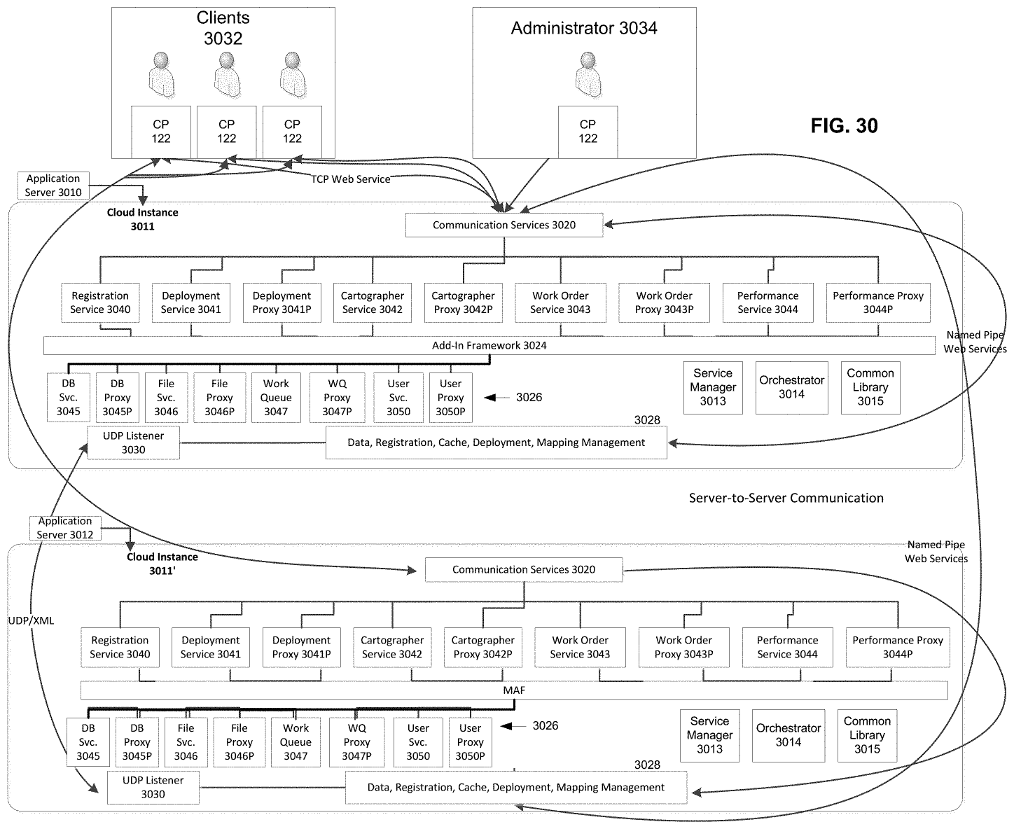

In general, the keymap system as described herein provides a mapping system that generates a key based on the data, or features related to data. They key identifies at least one target processing system from the many inter-connected processing systems. A synchronization system (e.g., see the registration service of FIG. 30 below) that maintains the availability of the many inter-connected processing systems. The synchronization system may be used to determine which target processing system should be used, e.g., if a primary target system is offline then a redundant system may be used as the target system.

FIG. 13 is an example of a PUT function using a keymap. The keymap and configuration is the same as in FIG. 12. However, when a PUT operation is used, the cloud proxy 112(r) must update both copies of the data for consistency. Otherwise, there would be no redundancy in the system. As shown, cloud proxy 112(r) issues two (2) total PUT commands A put command is issued to machine 2, as required by the keymap, and to machine 4, also as required by the keymap. This is another example of the consistency system that maintains that the information stored is the same across the appropriate machines.

FIG. 14 shows an example of an output for a hash function. In this case, a cryptographic hash function is used, such as the SHA-1 algorithm. The output of the hash function produces a twenty (20) byte output equivalent to one hundred sixty (160) bits. The use of the hash output may be further modified before applying to a keymap.

FIG. 15 is an example of a method for using a hash function to create a keymap distribution. This hashing system may be useful, for example, to create the keymap having an even distribution over machines for the expected number of accesses or uses during operation.

In step 1510, the input string is determined. Creating an input string is an example of how to map the set of data, as well as the identifier for the data. In this example, the set of data is the “User Preferences” and the data identifier is “Joe”. One method of creating an input string is to concatenate the set of data and the data identifier to create a unique input string. In this example, the input string (using concatenation and whitespace removal) becomes “UserPreferencesJoe”. Although the concatenation example is a simple method to produce an input string, other methods may also be used.

In step 1520, the input string may be input to the hash system, as shown here, the SHA-1 algorithm. As will be understood by one of skill in the art, the SHA-1 algorithm will cryptographically hash the input to provide a one hundred sixty (160) bit output while reducing collisions. Thus, the output of the hash will be substantially unique to the input.

In step 1530, the output of the hash may be modified, if desired. Here, no modification has taken place. If desired, the output of the hash may be modified, for example, to produce a lesser number of output bits (e.g., 8 bits), but with collisions. In an alternative modification, the arrangement of bits or bytes of the output may be reordered. One example of where the hash output may be modified is to produce collisions to group like-inputs. Alternatively, the output may be modified to produce collisions for unlike inputs. However, the methods used for creating a hash to produce collisions may be applied with improved efficiency by the design of the hash function itself, rather than a modification of the hash output.

In step 1540, the hash mapping distribution is determined for the keymap (e.g., see also FIG. 9) keyspace. A 20 byte (e.g., 160 bit) hash output may be mapped to 2\hat{ }160 (a large number). The mapping may be set to ranges on the number line (e.g., 0-N, N+1-M, M+1-P . . . to a maximum number) to allocate how many shards/slices the mapping will contain. In this example, a 20 byte number line is very large, so collisions are vanishingly improbable, which is a desirable criterion.

Alternatively, in step 1540, the hash mapping distribution is determined for the keymap (e.g., see also FIG. 9) keyspace. A 20 byte (e.g., 160 bit) hash output may map to a number line and divided into as many segments are desired. The byte groupings and byte values need not be consistent for mapping, although multiples of 8-bit groupings for mapping may be convenient. The hash output may be mapped to a keyspace by dividing the hash output on a number-line or on byte boundaries. In this example, the hash output is divided into four sections. The first section is zero to A, the second section A+1 to B, the third section B+1 to C, and the fourth and final section C+1 to D. If the hash output were evenly segmented, each section would include 5 byte groups (i.e., 80 bit groups) for each key segment. Thus, the segments/sections would include output bytes 0 . . . 5, 6 . . . 10, 11 . . . 15, and 16 . . . 20. The keyspace (see the horizontal axis of FIG. 9) can then be applied to the keymap and the machines (see the vertical axis of FIG. 9) assigned to each keyspace group. In another example, if the output of the hash function were a 10 bit number, the keyspace can be made by evenly splitting the 10 bit output 4 ways 0-256, 257-512, 513-768, 769-1024 (each segment having (2\hat{ }10)/4 possible values).

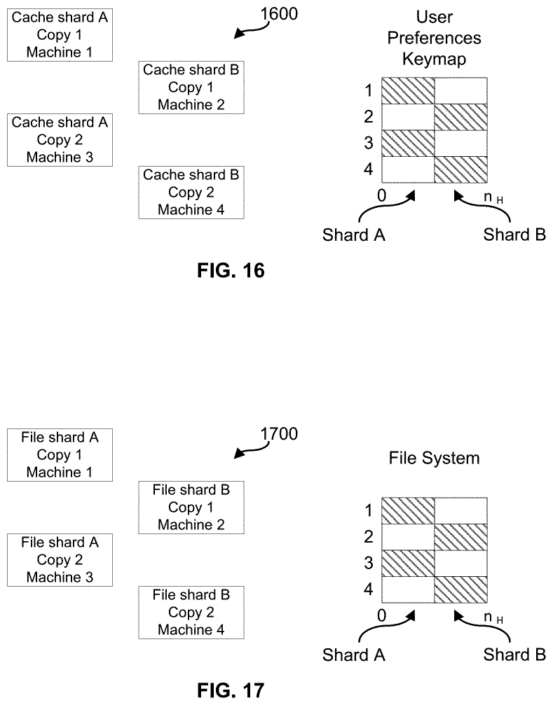

FIGS. 16-19 discuss basic applications within the cloud 130. These applications may be used by the cloud itself, or they may be used by clients accessing the cloud.

FIG. 16 shows a cloud-based cache system 1600. For example, objects, session data and/or metadata may be cached across the cloud for use by various machines in the cloud. In particular, the cache system 1600 may handle storage and retrieval of metadata and user data. This can be particularly useful for session management. In one example using session management, a first use may be assigned to machine 2 (see FIG. 12 for a GET function) and a second use may be assigned to machine 4. If session or state information is required with each use, the cache can provide the session information to any machine requesting it. Thus, in the first example, machine 2 can request the cached session object, and later, machine 4 can request the cached session object to perform another task. In this way, the session information may be stored and retrieved within the cloud 130 regardless of what machine the execution is taking place on.

The cache system 1600 may be sharded across machines to improve performance and also may include redundant copies of the cache data for reliability. As shown, shard A is copied onto two machines (e.g., machine 1 and machine 3) and shard B is copied onto two machines (e.g., machine 2 and machine 4) with shards A and B divided by the keymap as shown. In an example, if session information is stored in shard B, it may be stored redundantly and in parallel on machines 2 and 4. Either of machines 2 and 4 may independently supply data to a consumer and when the cache is notified that the session information changed, that changed information will be updated in parallel on both machines 2 and 4.

A cache system 1600 may be used to provide access and storage for objects and files. Typical caching may relate to session information that may be used across the cloud and have a low latency. Other caches may include objects that may be used between machines within the cloud and provide for canonical storage of objects. Although not required, a caching system may be configured for rapid access to the information. This allows for real-time sharing of an object throughout the cloud with low latency. Moreover, the cache may be designed to avoid blocking so that under all circumstances when an object is requested, it will be provided to the requester in a deterministic time period. The cache may be memory based, for speed, or file-based if persistence is needed. However, file-based systems may lead to unacceptable latencies unless the file-system is used for persistence and/or for fault recovery rather than caching objects under normal operating conditions.

The cache system 1600 may include sharding, which provides for a cache that is segmented across machines. This sharding approach may also provide for redundancy of the cache in the case where a machine fails or is taken off line. The sharding approach may also be used to provide a cache that is localized to particular machines where the objects may be more frequently used. For example, if a keymap for “user preferences” and “Joe” (see FIGS. 9 and 13) is assigned to machine 2 and machine 4, then certain processes executed on those same machines may also use cache information related to user “Joe”. Thus, the keymaps for the “user preferences” and the cached information may be mapped the same for user “Joe” in order to place the cache information on the same machine as the “user preferences”. In this way, the processes executed on machine 2 and machine 4 related to user “Joe” may have a higher probability of using the data local to the machine, rather than requiring access to machines 1 and 3, which uses network bandwidth and introduces latency. Cache system 1600 may also include, for example, a versioning mechanism that allows the requester to obtain a particular version of the object. In one example, the cached object may be a file or data.

Versioning may be used in cache system 1600 to maintain an audit trail and/or provide the ability to retrieve older data. It may also be used to reconcile the latest data between servers. A locking mechanism may also be provided that allows data updates to occur in a “first come first serve” fashion without race conditions.

Additional features to cache system 1600 may include indexing of predetermined information. For example, the objects being stored in cache system 1600 may be decorated to include indexed information that makes searching the cache possible by field. For example, a “user name” may be decorated for indexing, and then in use, cache system 1600 may provide a mechanism for searching for an object based on “user name”. Alternatively, when music-related objects are stored, the object may be decorated for indexing by “artist”, “release date”, “popularity”, etc.

As discussed herein, the cache system 1600 may use a journaled approach to object updates. However, other systems may use standard or custom serializers for persistence (e.g., the .Net serializer, PostgreSQL (or postgres) serializer).

FIG. 17 shows a cloud-based file system 1700. Such a file system may be used, for example, for persistent storage and retrieval of content (e.g., files). The files may be, for example, any files that may be stored on a standard file system.

The system may include a local directory structure that uses the hash key to identify the file. In an example, the file “Joe.jpg” may hash to “A4B72” and the file may then be assigned locally on the storage machine as “A4B72.jpg”. Additionally, to reduce the total number of files within a directory branch, the storage system may also use the hash key as part of the directory structure, and in an example, the file hashed to “A4B72.jpg” may be stored in directory “A\4\B\7\2\”. Moreover, the file system 1700 may include different versions of each file. Where the file is a “.jpg” file, the file may also include a small and large version. Thus, the file requested may be the original file or a modified version of it. In this example, the large file version would be “A4B72.large.jpg” and the small file version would be “A4B72.small.jpg”. Depending on the file type, there could also be clips or snippets for audio and video as versions of the original file.

The file system may be configured as a sharded and redundant system providing performance and reliability. Sharding information to multiple machines allows for parallelized operations, while duplication of shards provides for redundant operation. Data sharding may accomplish multiple objectives depending upon the architecture used. For example, using multiple instances may provide for higher performance and using duplication of shards provides for redundancy. Rebuilding of a sharded database may include copying the known-good data from a shard or it may provide for a journaling approach.

The journaling approach may be used when a shard is taken offline for a predetermined time. When brought back online, rather than copying an entire data shard (which may be time consuming), the newly online shard may request updates based on the transactions that occurred when it was offline, which may then be stored in a journal. The journal tracks changes over time so that, when requested, the changes during a time period may be requested to check consistency and to bring a system up-to-date. The journaling may use a log-file to track changes to the system in order to recover from a system failure. Where a shard is replaced, such as for a hardware failure or replacement, the shard may be re-built by copying the data from a known-good data source such as a known-good redundant shard.

The cloud may include a built in asynchronous data reconciliation mechanism that “audits” the data on various services and then “transforms” the data into either what it should be currently (i.e. the case that a server loses half a day's data) or what it should be in the near future (i.e. the hardware or keymap has changed such that the number of machines in the keymap has doubled and the system needs to spread that data out to reflect the new keymap). This audit and transform operation is either performed automatically (as a result of a server that recognizes it has been down and initiates this on startup) or by human intervention (e.g., 20 machines were added, and the keymap was changed to spread the data around across the machines in the cloud, including the new machines). To realize the transformation based on remapping the keymap, the system may include functionality for asynchronous work-order based processing. This may include large-scale calculations or time-intensive distributed operations that may take, for example, hours or minutes. These long term operations may rely on the asynchronous work-order based processing mode exclusively. In comparison, typical messaged traffic may handle requests quickly (e.g., on the order of seconds in the worst case). In general, asynchronous work-order based processing may comprise a cloud service that requests multiple sub-actions from other cloud services and then aggregates the sub-results before returning the final result. This may include sequencing of events, waiting for some sub-actions to return and be aggregated before other sub-actions are requested, and generally orchestrating the process of a long-duration action.

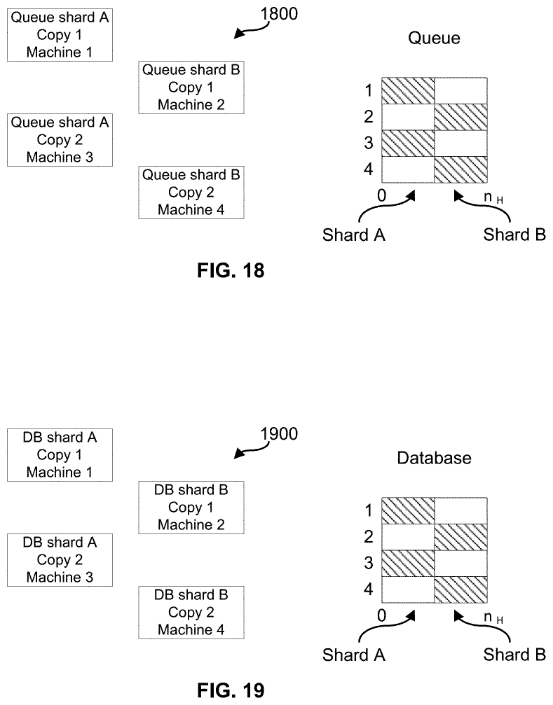

FIG. 18 shows a cloud-based queue 1800 and keymap. This may be used as an object or job queue within the cloud computing environment. For example, where a process requires a step of sequences to be processed, they may be added to the queue. In an example, the cloud-based queue 1800 may be used to handle asynchronous object processing for tasks such as user submission of their existing music collection metadata (i.e., also known as “scrobbling”).

Each cloud proxy 122 may coordinate with the queue to de-queue a task to be performed if the machine is available for use. In this way, a long-running or parallelized process may queue up the tasks to be run, and the cloud 130 will handle taking jobs from the queue, performing the tasks and returning the results to the proxy. As shown, the queue may be sharded and have redundant copies to enhance performance and reliability. The queue may also use a log to provide a recovery mechanism in the case where a queue goes offline or is in a failure mode. When the queue comes back online, it may request transactions that may have occurred to synchronize with the known-good queue.

FIG. 19 shows a cloud-based database 1900 and keymap. In an example, the database 1900 may be an object oriented database or a relational database. The sharded configuration of the database 1900 provides for increased performance of the system. Redundancy is built in by use of copies of the shards across different machines.

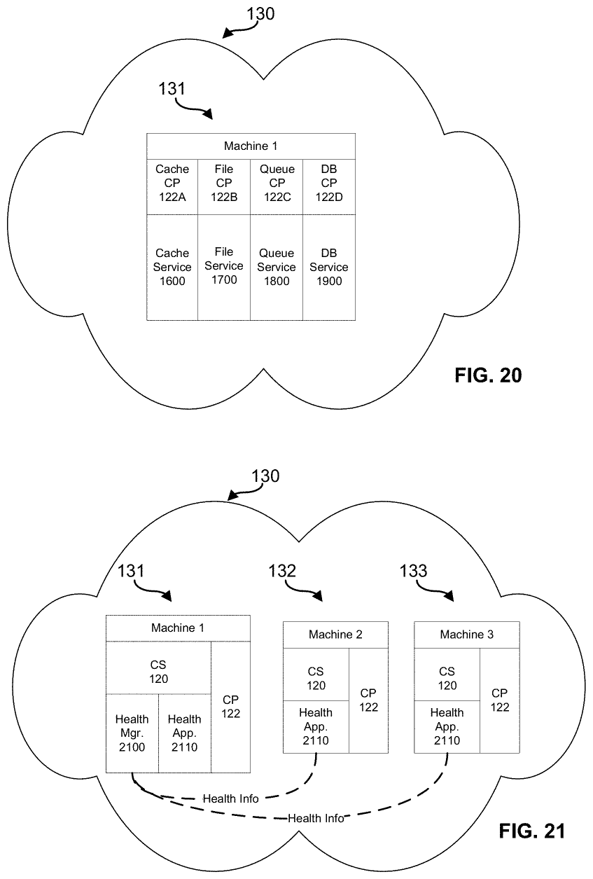

FIG. 20 is an example of cloud client service instances and cloud proxy instances on machine. In general, each service may have its own proxy. In this example, add-in software modules include a cache proxy 122A is related to a cache service 1600 (see also FIG. 16), a file proxy 122B is related to a file service 1700 (see also FIG. 17), a queue proxy 122C is related to a queue service 1800 (see also FIG. 18), and a database proxy 122D is related to a database service 1900 (see also FIG. 19). In general, each machine 131 may be configured to include multiple software modules (including proxies and services) for performing different functions. Other add-ins may be added to the framework, including but not limited to, search engine, auto-complete, recommender, data analysis, reporting, media encoding, business intelligence, data mining, signal processing, modeling and simulation, pattern recognition, rendering, etc.

Cloud proxies 122 may be located inside the cloud 130 or outside the cloud 130. When placed outside the cloud (such as is shown in FIG. 12 with cloud proxy 122(r)), the cloud proxy may be a scaled-down version with less functionality than a cloud proxy 122 inside the cloud that may provide for job synchronization and/or marshaling of parallel processed data.

The cloud client service and proxy hosting may be configured as an add-in framework that accepts different software modules, and different versions of software modules. In an example, the Microsoft® .Net add-in model supports deployment of add-ins to a host. Moreover, the add-in framework provides for isolation by way of application domains (“app domains”) that can either isolate an add-in from other add-ins with different app domains, or can provide for the sharing of resources for add-ins with compatible app domains. The add-ins may also be isolated from the host by way of app domains. In other nomenclature, the use of app domains may be used to “sandbox” the add-ins from the system and each other. Because the app domains provide a wide variety of resources to the add-in, security may be handled internally by the app domain and a security policy may be applied across the cloud 130 for each app domain.

In general, each proxy exposes the same outward facing interface as its service. Thus, calls to either a proxy or a service take the same over-the-wire format even though they are at different endpoints. A proxy can either be hosted inside of or outside of the cloud or both. Each proxy can have its own business logic specific details for request routing using the keymap and response aggregation after talking with its service. However, typically only a proxy will route, aggregate, or have cloud knowledge. A service can call any other local proxy or service which melds together all different types of add-ins (i.e. the queue talks to a local cache service, whereas in other applications we have an add-in service that talks to a local cache proxy).

Discovery, versioning, and termination of an add-in may also be handled by the add-in framework. For example, deployment of an add-in may be as simple as configuration and deployment to an add-in location (e.g., a folder) and the add-in framework can then discover the add-in. Versioning may also be supported by the add-in framework. Versioning may be used, for example, where there is a cloud cache version 1 and a cloud cache version 2. The compatibility of the cache versions may not need to be managed by the add-in framework, but if an instance of a cloud cache version 1 exists in the cloud, then it would communicate via the framework with the cloud cache version 1 that resides locally to a machine. Similarly, the cloud cache version 2 add-ins may communicate with each other. In this way, the add-in framework supports multiple instances of a cloud cache that may have different versions operating within the same cloud and without interfering with each other.

FIG. 21 is an example of a cloud health management system 2100. The heath management system may receive information related to the utilization and health of each machine, and or each add-in, operating within the cloud. The health information may be provided by health application add-ins 2110 that may be resident on each machine. At the machine-level, the health application 2110 may compile statistics on CPU utilization, RAM utilization, disk space utilization, network throughput, network errors, component heat, etc. in order to provide a full analysis of the machine. At the add-in level, health information may include average and maximum latency (e.g., in a cloud-based cache system, see FIG. 16), a read/write time (e.g., for a cloud-based file system, see FIG. 17). Given all of the information related to each machine and each add-in, the health manager 2100 may apply policies and methods to determine the state of the cloud's 130 health, and also implement procedures to report and/or initiate corrective actions.

Information may be collected internally by each add-in and others may be collected by Simple Network Management Protocol (SNMP), as well as machine-specific monitoring and/or logging software.

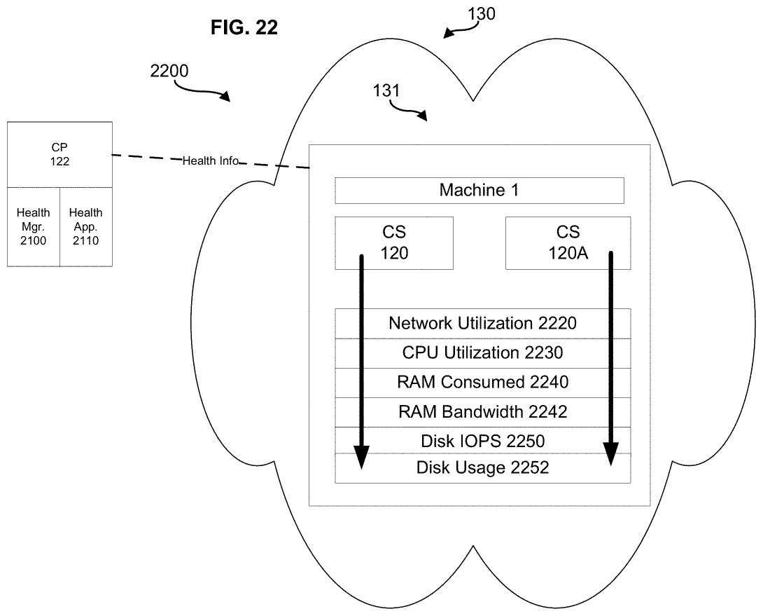

FIG. 22 is an example of a granular cloud health management system 2200. In a granular health management system 2200, the resource contention on a machine may be diagnosed based on the cloud services 120 operating on the machine. The cloud services 120 may then be identified for further study or adjustment to improve performance of not only the machine 131, but also the cloud 130 overall. In this example, cloud service 120 and cloud service 120A share and use the resources of machine 1 (131). Here, cloud services 120, 120A may consume and a health manager may report how much is used and at what time. This can be helpful to determine problems with machine performance. For example, resources tracked may include network utilization 2220, CPU utilization 2230, RAM consumed 2240, RAM bandwidth 2242, disk IOPS 2250, and disk usage 2252.

In one example, focusing on performance issues, the disk IOPS 2250 metric may be highly relevant to analysis of poor machine performance. In an example, machine 1 (131) may include multiple cloud services, each having at least one thread accessing a disk resource. When multiple cloud services are trying to read and write at a high rate, the performance of the machine may slow to a crawl, which may be 1/10^{th} of the regular read/write speed. Such slowdowns may occur with as few as ten threads performing read/writes simultaneously. In determining the reason for a machine slowdown, each of the metrics may be inspected. Upon discovery of the root cause, the cloud 130 may be adjusted to either balance the load in a more performant manner, or the cloud services 120, 120A may be re-designed to avoid slowdowns. Although network, CPU, RAM and disk metrics are shown in this example, other metrics may also be collected at the machine level as well as the service and cloud level. Given the granularity of the data, problems and bottlenecks can be easily identified for correction.

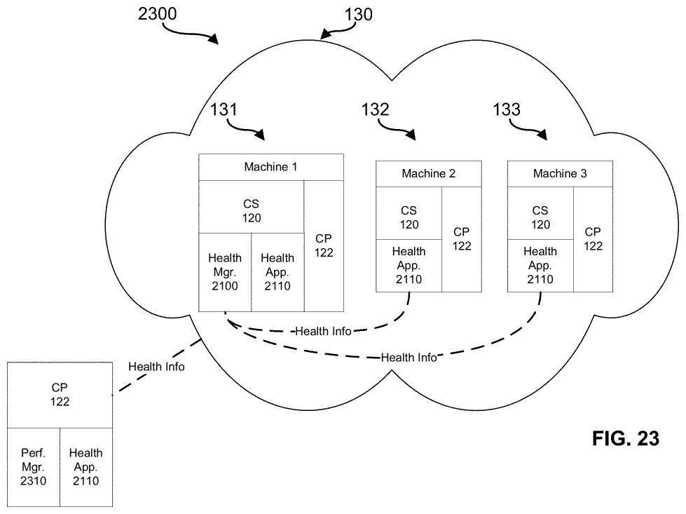

FIG. 23 is an example of a performance analysis system 2300. A performance manager 2310 may receive health and performance information from health mangers 2100 and heath applications 2110 from within cloud 130. Performance analysis system 2300 may be located within cloud 130 or outside cloud 130. In general, the performance of the entire cloud 130 may be analyzed for throughput and efficiency. This may include network usage (e.g., important when using WAN for data storage), CPU utilization (e.g., important when determining how many servers to allocate), and power consumption. The performance information may be collected for the entire cloud 130 and each of the machines used for cloud 130. Moreover, 3^{rd} party cloud support systems are being used for data processing and/or data storage, the cost and response time can be measured and compared to owning and configuring your own hardware.

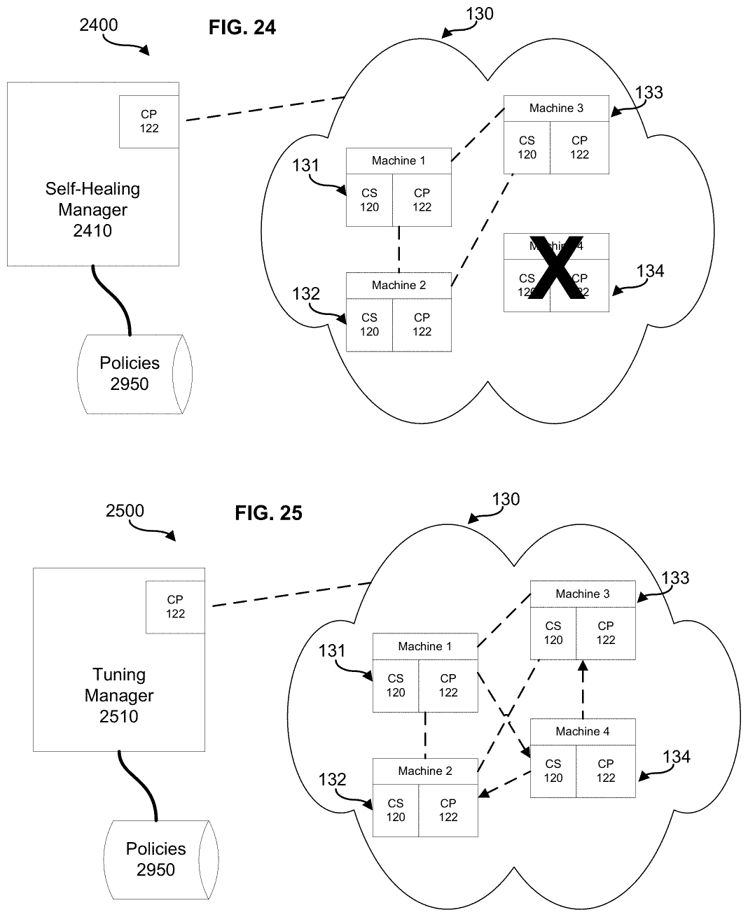

FIG. 24 is an example of a self-healing system 2400. Self-healing system 2400 may operate by rules that determine the health of the system. When components fail, or the system becomes less performant, the system itself may heal itself by reconfiguring. For example, if a portion of a database is copied across 2 machines for redundancy, and one machine goes offline, self-healing system 2400 should take action to preserve the integrity of the data held that no longer has redundancy. In one example, self-healing system 2400 may issue asynchronous work-order based processing to initiate a copy of the data at risk. However, if the data is considered vital, the process may begin immediately and have foreground privileges.

FIG. 25 is an example of a self-tuning system 2500. In this example, machine 4 (134) is overloaded with disk IOPS and needs to reshuffle the persistent data. Tuning manager 2510 may detect this performance problem and store it to a log. If a predetermined time has passed and the problems do not re-occur, then nothing may be done. However, if a predetermined time has passed and the performance problem still exists, then the system may choose to self-tune to improve performance. In one example, machine 4 is overloaded. Self-tuning system 2500 then begins to aggregate the information about each machine's performance as well as the performance of each add-in. Self-tuning system 2500 can then determine which machines can take on more load and adjust the keymap accordingly such that cloud 130 improves overall performance. In general, the system may be operated by rules and behavior, utilization of resources, and transmission of information across the cloud. Each may be measured and an ideal balance may be achieved through automatic adjustment of the keymap and resources.

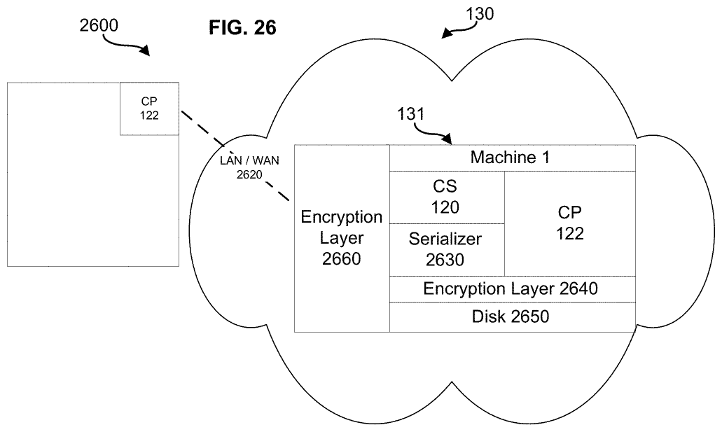

FIG. 26 is an example of a cloud security protocol system 2600. Each machine 131 may include specialized security for network access inside and/or outside cloud 130. Moreover, the cloud service 120 may include encryption with the machine 131 to handle serialization of sensitive information. In one example, cloud service 120 may need to persist data to disk. Thus, the output of the serialization process must be encrypted before persisting to disk to maintain protection on the data. In a first step cloud service 120 determines a need to persist data to disk. Cloud service 120 may use a serializer 2630 to convert an object or data structure to a persisted state. The serializer 2630 may be the typical .Net serializer or it may include other serializers such as PostgreSQL. However, the security of the AppDomain may be jeopardized by using serializers outside the AppDomain. Built-in serializers such as the .Net serializers may be preferred because the data does not have to leave the AppDomain as unencrypted.

An encryption layer 2640 may belong to the AppDomain and simply encrypt the serialized date for persistence. The encryption layer 2640 may also handle decryption when objects are recalled from their persisted state.

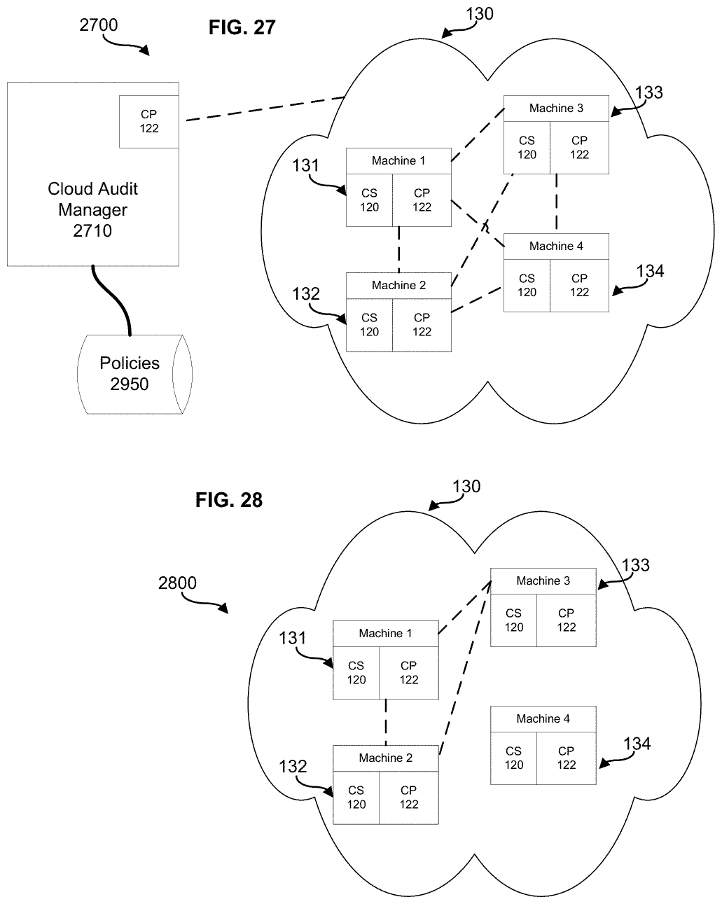

FIG. 27 is an example of a cloud audit system 2700. A cloud audit manager 2710 may have access to the cloud to determine if policies 2950 are being enforced. For example, cloud audit manager 2710 may work through a list of each cloud service 120 and cloud proxy 122 to determine if encryption is being utilized. Alternatively, cloud audit system 2700 may check the redundancy of the persisted and non-persisted data and verify that minimum standard is being met.

If policies are not being met, cloud audit system 2700 may make a log, notify an administrator, or notify the cloud itself. For example, the cloud may be configured to self-heal, in which case the cloud may start the process to copy data at risk of being lost to other machines. If the minimum requirements are being met, and there are no problems detected, cloud audit system 2700 may make a log indicating that all policies are being followed. This log may be deemed important to business operations to prove that cloud 130 is healthy, and during what time periods.

FIG. 28 is an example of a cloud power management system 2800. Cloud 130 comprises four physical machines 131, 132, 133 and 134. However, during periods of low activity, not all machines need be active. Thus, the cloud may include a power management strategy that may turn off machine 4 (134) during the low activity period. To wake up, machine 4 (134) may include a feature Wake-on-LAN feature such as a “magic packet” or other wake up mechanism. Such power saving strategies may be helpful to conserve energy for services that have peak hours and non-peak hours. However, taking a machine down may require a restructuring of the cloud to ensure data redundancy is met at all times. Moreover, the persisted data (if any) may require updating when machine 4 (134) comes back online. In a maximally efficient configuration, the machines targeted for selective shutdown may not include any, or have minimal, persistent data to avoid high network bandwidth disturbances for online updating. In one example, the machine may be shut down when the machine itself becomes 90% idle (being a machine-load dependent decision). In another scenario, the machine may be taken down when the cloud is less than 50% idle (being a cloud utilization dependent decision). Moreover, application add-ins may need to be deployed to each machine to control their own on/off condition as well as be able to wake-up a shutdown machine if the load increases above a predetermined threshold. The power management system may be purely software based or it may include a dedicated or semi-dedicated hardware solution. In general, machines may “sleep” when not needed, and then wake up when needed. The system may also determine which machines are most efficient and leave those on, idling the high power consumption machines.

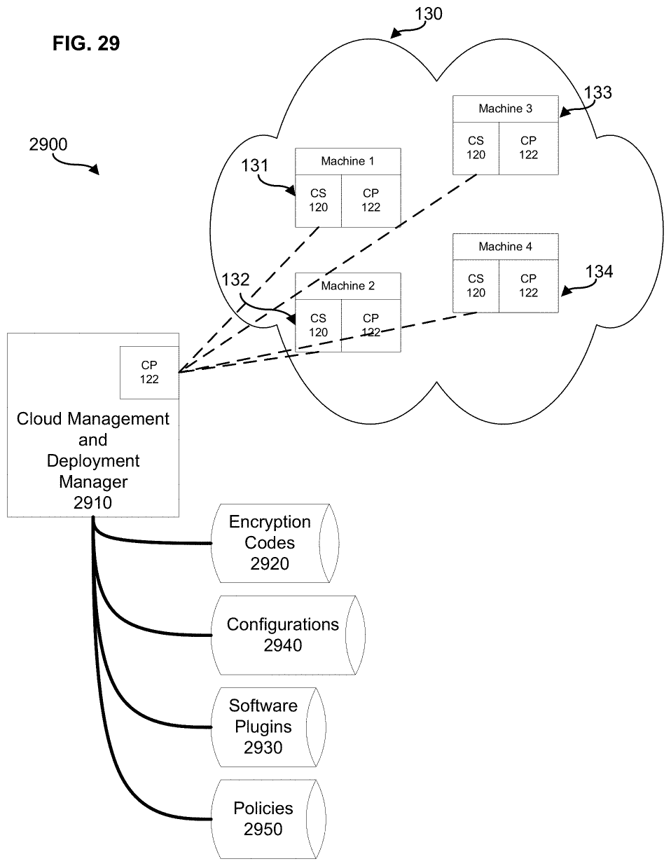

FIG. 29 is an example of a cloud management and deployment system 2900. A cloud administrator may be required to implement and deploy cloud 130 to a predetermined configuration at any time. To this end, cloud management and deployment system 2900 may be used to deploy software plugins, configure security, and verify the installation of cloud 130.

A software program or system accessible to the cloud administrator may include a cloud management and deployment manager 2910. The deployment manager 2910 may include a cloud proxy 122 for communication with prospective machines 131, 132, 133, 134. The machines 131-134 may be installed with a bootstrap-type cloud proxy for initial configuration and deployment. Thus, deployment manager 2910 may not require special installation of software (e.g., using a disk drive or the like) in order to deploy a cloud computing system.

Deployment manager 2910 may be manually controlled by the cloud administrator or it may include a script or deployment file that can automatically control deployment of the desired add-ins and software modules. Deployment manager 2910 can access a number of repositories that may include encryption codes 2920, software add-ins 2930, configurations 2940, and policies 2950. These repositories may be local to the deployment manager 2910 (e.g., on disk) or they may be accessible via a network.

Encryption codes 2920 may include the encryption keys for communication over a network (public or private), encryption keys for persistence of data or transmission over a network (e.g., when serializing), as well as keys or codes for accessing cloud proxies that may be local and/or accessible over a wide area network.

Software add-ins 2930 may include the software modules for deployment to each machine. These may include the proxies as well as add-ins. For example, the software add-ins may include a cache proxy, a cache service, a file proxy, a file service, a database proxy, and a database service, just to name a few. Moreover, software add-ins 2930 could include cloud proxies and other support software modules that may need deployment to each machine in the cloud.

Configurations 2940 may include the configuration information for each software module as well as the configuration information for the cloud itself. For example, the cloud configuration may include the network information such as a subnet and subnet mask, the number of machines to deploy to, the MAC address (or other unique address) that can identify particular machines if desired, DNS servers, connection strings, AppDomain s for each software module, the encryption systems applied (if any), and other configuration information. Examples of deployable configuration information may include an “app.config” or “web.config” file (when using .Net). The configuration files could be pre-generated and stored or they may be constructed or modified by deployment manager 2910. These may include general information about how to initialize the software add-ins as well as contain connection information, endpoints, and the like to allow the software add-ins to function within cloud 130.

Policies 2950 may include information about what policies to apply to software modules, communications and/or data within cloud 130. Policies 2950 may determine how each software module operates within the cloud, what resources are used, what the performance targets are, etc. The policies 2950 may also be multi-level policies applied to the low-level software, but applied differently to the high level architecture of cloud 130. An example of a policy for a cloud file system may include a minimum level of redundancy (e.g., 2 copies), a maximum volume size for a shard (e.g., 2 TB), and a strategy for notification and recovery if a drive fails (e.g., the minimum redundancy is not being met), how to handle deprecated software interfaces, etc.

FIG. 30 is an example of the cloud computing architecture 3000. As shown, the example only shows and describes two application servers 3010, 3012. However, it is understood that typical system configurations may contain more than two application servers and common configurations may contain any number of application servers 3010, 3012. Each application server 3010, 3012 contains a communication services module 3020 that provides communication between application servers 3010, 3012 and any other application servers that may be connected via the same or various networks. The communication services module 3020 may be configured for a variety of interface schemes, including but not limited to, WCF, JSON, or SOAP standardized XML messaging. The communication services module 3020 may also provide communication within each application server 3010, 3012, as well as providing the communication to other application servers using a network. In general, a common configuration for communication services module 3020 may use WCF which in turn utilizes Transmission Control Protocol (TCP) with Internet Protocol (IP), together TCP/IP.

The example cloud computing architecture 3000 includes a distributed system that may include pluggable add-ins using a common cloud system infrastructure. Examples of add-ins may include a database, a search engine, a file system, etc. as described below. The add-ins may execute on the processor of the application servers 3010, 3012 to provide core functionality of the cloud system framework. Cloud instances 3011, 3011′ of the cloud system may execute on each application server 3010, 3012 participating in a cloud group.

In an example, instances of the cloud system may execute as Windows services. However, other systems may be used to implement instances of the cloud system, such as Apache Tomcat, Java Web Services, etc. When developed using .Net, the cloud system may be implemented on MONO using a variety of operating systems. In an example, the application server 3010 may be configured for use in a Windows environment, in which case the application server 3010 can be a Windows service that starts and exposes the cloud instance 3011 services, as well as optional services, and may orchestrate the sending and receiving of UDP messages to maintain the status of each cloud instance 3011 (see below).

The communication between cloud instances may include socket-based TCP, “named pipe” transport, or UDP transport. The cloud instance 3011 may include a channel handler that provisions the channels requested by the various components of the cloud instance. The cloud instance may use a managed communication channel approach or a pooled approach. The pooled approach allows for recycling of communication channels, thereby reducing the penalty to create a new channel for each communication. The managed approach allows for the maintenance of a list of the channels for each cloud instance 3011. When a client (e.g., a proxy) requests a communication channel, the channel manager may attempt to borrow an existing channel, return a free channel, create a new channel (if the maximum number of channels is not already reached) or return the least-used channel for the cloud instance 3011. Depending upon the physical network arrangement, the channel manager may be modified to maximize throughput and reduce performance penalties.

Each cloud instance 3011 may include a service manager 3013, an orchestrator 3014, and a common library 3015 that are used in the control and management of the cloud instance 3011. The service manager 3013 may be a distributed service that runs alongside each cloud instance 3011 that provides a means to initiate shutdown or startup of the cloud instance 3011. For example, if a system upgrade is desired, the service manager 3013 may stop the cloud instance so that it may be upgraded. The service manager 3013 may then start the cloud instance 3011 after the upgrade is complete. The common library 3015 provides a repository for utility classes and functions that are commonly used in the operation of the cloud system and/or the add-ins.

The orchestrator 3014 is a client-side class that provides a granular (low level) variant of the service manager 3013. For example, the orchestrator 3014 may be addressed by machine address (e.g., IP address) and can provide low level access in an out-of-band fashion to the cloud system. For example, when an administrator desires to turn off specific cloud instances 3011 without shutting down the entire cloud system, they may use the orchestrator 3014 and address each cloud instance 3011 individually for shutdown. In another example, if there is a systemic issue within a cloud instance 3011 that requires shut down of a single cloud instance 3011, multiple cloud instances 3011, or all cloud instances 3011, the orchestrator 3014 provides a means to shut any, some, or all nodes down automatically at once or in sequence, rather than manually one at a time. The granular nature of the orchestrator 3014 allows specific nodes to be turned off without having to shut down the entire system. This can serve as a patching mechanism or a rolling reboot tool.

Within each application server 3010, 3012, the cloud system may include the communication services module 3020, the UDP listener 3030, core functionality modules 3022, an add-in framework 3024, consumer add-ins 3026, and basic services 3028. Servers communicate with each other via a self-discovery mechanism, periodically sending and receiving User Datagram Protocol (UDP) packets with status information. An example of communication may be provided by a UDP listener 3030. UDP listener 3030 may receive/consume UDP messages to listen for UDP-based events, such as the UDP multicast strategy for identifying and determining the status of each proxy 122 (see FIG. 2). In general, the UDP messaging scheme allows the cloud system to determine when a service (or machine) comes online, when they go offline in a controlled manner, and when they go offline in an unexpected manner. The UDP listener 3030 may be used to provide high-level information about the status of each application server 3010, 3012, as well as the status of each of the add-ins such as core functionality modules 3022, consumer add-ins 3026, and basic services 3028. The cloud system may identify the participating systems using the self-discovery mechanism (see FIG. 3). Under normal conditions, when each instance of the cloud becomes active, a UDP message is transmitted indicating the online status and when going offline a UDP message is transmitted indicating the offline status. However, periodic UDP messages may be transmitted and when not received by other participants of the cloud system, the instance failing to periodically transmit may be deemed offline by the other participants. In this way, the cloud system can identify the participants as well as identify when a problematic instance may no longer be available.

Core functionality modules 3022 may include, but are not limited to, a registration service 3040, a deployment service 3041, a cartographer service 3042, a work order service 3043, a performance service 3044, a database service 3045, a file system service 3046, and a work queue service 3047. Each of the aforementioned services, except for registration service 3040, may include proxies such as a deployment service proxy 3041P, a cartographer service proxy 3042P, a work order service proxy 3043P, a performance service proxy 3044P, a database service proxy 3045P, a file system service proxy 3046P, and a work queue service proxy 3047P. Generic developer implemented services 3050 and proxies 3050P may be plugged in using the add-in framework 3024.

The core functionality modules 3022 and consumer add-ins 3026 may be implemented as pluggable add-ins using add-in framework 3024. An example of an add-in framework 3024 is Microsoft's Managed AddIn Framework (MAF) that provides a framework to deploy add-ins and ultimately control their activation at the deployment. Moreover, MAF provides independent versioning of the host (e.g., the cloud system) and the application add-in. This allows for multiple versions to exist on the cloud system which may be useful when data is versioned and/or when data is being modified to a newer version or rolled-back to an older version. The MAF may also enable the cloud system to pull add-ins from a defined store, which may provide a “pull” feature for the add-in when its use is desired. A MAF-type system may also provide isolation of one add-in to another, and to the cloud system in general. In this way, the failure of an instance of the cloud system on an application server 3010, 3012 may be eliminated or handled gracefully if an unexpected malfunction occurs in an add-in. A form of process isolation may be to define application domains to each add-in such that an unexpected malfunction does not hinder the remaining system or other add-ins.

The registration service 3040 maintains a real-time, or near real-time, status of all of the physical instances of the cloud system, all of the logical services (e.g., core functionality modules 3022, consumer add-ins 3026 and basic services 3028, communication services module 3020, UDP listener 3030, add-in framework 3024, etc.), and their related proxies. In communicating, the registration service 3040 may consume UDP messages (see above UDP listener 3030) to receive information about other cloud instances 3011′. An example of UDP consumption may be a known schema using XML to receive and transmit status information about each cloud instance 3011. Using the same protocol, the registration service 3040 may collect information about each item of interest, format the data, and provide XML that is broadcast-ready to be transmitted by communication services 3020 or other communication service.

General state information is available including, but not limited to, “healthy”, “suspended” and “stopped”. A state of “healthy” indicates that instance is ready for use. A state of “suspended” means that the service is not immediately available to act, but may be able to receive queued information (such as when memory “garbage collection” is underway). A state of “stopped” indicates that the service is not available for use. In addition to providing state information to the services internal to the cloud instance 3011, the registration service 3040 also collects and provides state information about cloud instance 3011 to other cloud instances (e.g., cloud instance 3011′).

In general, the registration service 3040 may provide information about the availability of any or all of the instances of cloud elements, and their services. This information can be used by any of the distributed computing elements discussed herein to make decisions for location, communication and general availability of a service or computing element. In general, the registration service 3040 identifies each cloud elements and their respective local resource(s). In this way, the registration service 3040 is able to identify what services are available for each cloud instance.

The deployment service 3041 works with the add-in framework 3024 to start and stop cloud services, installing new services, installing/updating new services, or generally deploying data to the system (e.g., assemblies). The use of deployment service 3041 may be by a management system (e.g., cloud management) and/or by a scripted routine.

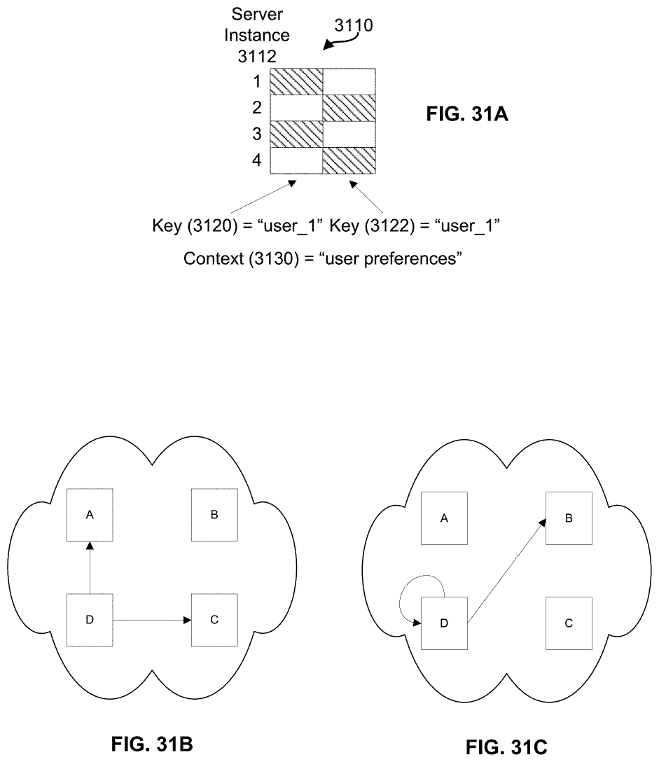

The cartographer service 3042 creates and maintains keymaps (see FIGS. 6-19) common within each cloud instance. As described above, a keymap generally maps data to a cloud instance and vice-versa, which allows each proxy to determine where the data is stored. In an example, FIGS. 31A-31C demonstrate a keymap system to locate data. Mapping information may be provided by the cartographer service 3042 to determine which of the cloud instances may contain certain data. In an example, if a particular data key is provided to the cartographer service 3042, the cartographer service 3042 may reference the keymap using the data key to determine which cloud instance may contain the desired data (e.g., mapped data).

The cartographer service 3042 may be configured to map a key derived from an aspect of the mapped data to at least one of the instances of cloud elements. For example, as shown in FIG. 13, the mapping may be based on the data being sought for user preferences (e.g., “user prefs”) and the particular user is identified as “Joe”. The aspects of the data are then the context (e.g., “user prefs”) and the particular user name (e.g., “Joe”). However, other aspects may be used as well as described herein to include the size, date, other contexts, zip code etc.

The cartographer proxy 3042P may also be in communication with the other cartographer proxies 3042P and cartographer services 3042 of the cloud system. For example, this communication facilitates exchanges of information for keymaps and coordination of keymap updates.

As shown in FIG. 12, the cloud proxy 112(r) is shown as an example of an access proxy. The access proxy may be configured to be substantially similar to, or if desired identical to, the cartographer proxy 3042P, wherein the access proxy is configured to allow communication to the plurality of instances of cloud elements. In an example, the access proxy may be an instance of the cartographer proxy 3042P that is in communication with the cloud, but may not include cloud functionality such as the user service 3050 etc. However, the access proxy may be supported by the other basic elements of the cloud instance 3011, such as the cartographer service 3042, registration service 3011, deployment service 3041, work order service 3042, etc. If desirable, the access proxy may include substantially all of the functionality of a regular cloud instance 3011, or it may include a subset thereof. In general, the access proxy may be used to access the full services of the cloud without participating fully in the cloud functionality, such as storage, caching, user services 3050 etc.

Generic developer implemented service 3050 and proxies 3050P may be considered a local resource that the developer may configure to process data. In general the service 3050 may include a local service configured to manipulate the mapped data at the cloud instance. The proxy 3050P may be used to allow the service 3050 to communicate with the cloud as a whole (e.g., providing a communication interface to the cloud), as well as provide mapping and aggregation functionality. The local resource may provide a response (e.g., after being communicated with) after performing an action on the data. For example, if asked to store data, the response may indicate success or failure. If a request is made, the local resource may provide a response that includes the data requested. Manipulation of the mapped data by a local resource may include, but is not limited to, storage, retrieval, modification, addition, deletion, etc. A simplified example of a local service may be to persist data on local storage (see also FIG. 40). When local storage is available to a local service, the service may maintain a copy of the data in memory or on disk, and access the storage without using network communication (e.g., since it is local).

The proxy 3050P may provide business logic level integration to the local service. In an example, the local service 3050 may require certain data that is local and other data that is provided by other cloud instances. In this case, the proxy 3050P may request the data from the other cloud instances and aggregate the result for the service 3050. This simplifies the architecture for implementation by separating the cloud logic from the local service 3050. However, other examples may include additional modifications and/or aggregations at the proxy level to avoid, if desired, injecting the cloud logic into the service.

Each of the services and proxies may be considered an execution service, and depending on their configuration may be used to request data, modify data, provide data, and store data. In general, the functionality may be based in both the service and the proxy and they may work individually or in concert to perform the execution service.

FIG. 31A is an example of a simplified replicated keymap. The keymap 3110 maps a cloud instance/slice to a key 3120, 3122. As shown, a context 3130 is “user preferences”. However, the cartographer service 3042 may maintain separate keymaps for each context, for some of the context, or use a single keymap for all contexts, depending on the desired implementation. As shown, the key for “user_1” maps to instances A and C. The key for “user_2” maps to instances B and D. The multiple mapping provides the basic mechanism for replication (in this case the data is replicated at two servers), which provides data and processing redundancy in the cloud system. To achieve proper redundancy the system may also employ a consistency system that forces the information stored on various instances to be the same.

FIG. 31B is an example of a cloud instance identifying a location for context “user preferences” and a key “user_1”. As shown, the keymap is used by cloud instance D to determine that the data for context 3130 “user preferences” and key “user_1” 3120 is located at cloud instances A and C.

FIG. 31C is an alternative example of a cloud instance identifying a location for context “user preferences” and a key “user_2”. As shown, the keymap is used by cloud instance D to determine that the data for context 3130 “user preferences” and key “user_2” 3122 is located at cloud instances B and D (itself).

Turning back now to FIG. 30 and cartographer service 3042, the keymap may be transformed using a crypto-hash to uniformly distribute the key into a number between 0 and 20 bytes (see also FIGS. 14-15 as it relates to the keymap). A proxy (e.g., deployment service proxy 3041P, cartographer service proxy 3042P, work order service proxy 3043P, performance service proxy 3044P, database service proxy 3045P, file system service proxy 3046P, work queue service proxy 3047P, etc.) may use the crypto-hash and the keymap to determine which instance(s) the data related to the crypto-hash is located. Once the instance(s) are determined, the cloud system, and in particular the proxy, knows the location of the keyed data. Thus, the location for the proxy to communicate with to operate on that data (manipulate, read, write, save, delete, etc.) is known and the communication may be initiated.

The work order service 3043 may be used to schedule long-running or task-related jobs that are not required to be done in real-time or near real-time. Examples of work order jobs may include bulk updates, complex calculations, etc. The work order service 3043 generally provides a framework for asynchronous operations on a cloud instance 3011. The work order service 3043 may provide the status of work order jobs that are currently being performed, jobs that have been performed in the past, and jobs that have not yet been performed (e.g., queued jobs). The work order service 3043 does not typically interrupt operation of the cloud instance 3011 and provides that the other services in cloud instance 3011 may continue to operate without interruption while the work orders are being performed. Exceptions may include circumstances where the work order needs to lock data or processes to perform the job.

The performance service 3044 provides a framework for measuring the performance or health of the cloud instance 3011, and the application server 3010. The performance service 3044 may measure how the cloud instance's 3011 basic resources are being used and expose those metrics/counters to developers for design and maintenance, the cloud instance itself for re-tuning, and/or the cloud system as a whole.

Examples of performance metrics may include the amount of RAM consumed and available, the average and peak CPU loads, etc. As discussed above with respect to FIG. 22, the performance service 3044 may measure any number of metrics for the machine/instance. Additional information may be collected that relate to inter-operability of cloud instances 3011 such as delay times, drop-outs (e.g., instances going offline), etc. A cloud configuration and/or management tool may be used to view and analyze the performance metrics. However, the cloud instance 3011 itself may also use the performance metrics to determine its own status, send messages related to status, and fine-tune operations to maximize performance. In general, the performance service 3044 may actively monitor performance counters (e.g., calls per second, call duration, successes, failures, consumption attempts, etc.) on all the physical and logical resources (e.g., CPU, RAM, hard disk, network connections, etc.) that each cloud server consumes. In addition, developers may create specialized metrics/counters for use and reporting by performance service 3044.

The database service 3045 may generally comprise a database management system. In general, the database service 3045 may include a high-performance, in-memory database with integrated disk-based persistence. The database service 3045 may be used as a distributed cache (e.g., primarily for in-memory applications) or as a data engine for a product (e.g., primarily persisted data). In an example, the database service 3045 implements an object database. In another example, the database service 3045 may expose a relational database. Alternatively, the system may implement an object database, but also provide access to a relational database. When used as an object database, the same keymap system (e.g., via cartographer service 3042) may be used to access stored objects. The objects may be persisted on disk locally to each cloud instance 3011. The objects may also be stored/retrieved by the same cloud instance 3011 or other cloud instances 3011′ using the proxy.

The file system service 3046 provides an interface for persisting files. This is to be distinguished from an object database. The file system service 3046 may be tuned for providing raw file storage and retrieval to and from a disk system. This may include storage of content, such as images, multimedia files, etc. The file system service 3046 may also be tuned for persisting files to local disk (such as with a DAS) thereby abstracting the file handing from the other mechanisms of the cloud system, while also providing a unified interface to the cloud system for storing and retrieving files. Additionally, the file system service 3046 uses a keymap-based distribution and replication system which provides all of the benefits of keymap system.

The work queue service 3047 provides a general queue for use by the cloud system. This may be used, for example, by the work order service 3043 to queue requests for jobs. In general, the work queue service 3047 may comprise a distributed queue system for use by the cloud system.

Consumer add-ins 3026 may include applications such as an indexing/retrieval system (e.g., a search system), a general queue, a MetaBase (e.g., a data store/database of meta-information such as configurations or relational business domains), etc. Each of the consumer add-ins may use the cloud services such as the database service 3045, file system service 3046, and work queue service 3047, etc.

Using the cloud system, developers may easily install/deploy pre-built modules to the cloud system. The developers may modify legacy application to operate within a cloud environment with relative ease since the mapping and services are integrated within the cloud system. Provided the cloud environment, the adaptation of existing systems increases legacy usability and reduces new sources of errors. At the same time, the cloud system increases performance, scalability, and redundancy with the built-in core functionality modules 3022. The developer may also design new distributed applications with minimal overhead to manage a cloud-based platform. In general, the cloud system encapsulates the complex tasks of creating and managing a custom, distributed application in a simple, easy-to-use framework, allowing clients to solve their unique business problems efficiently.

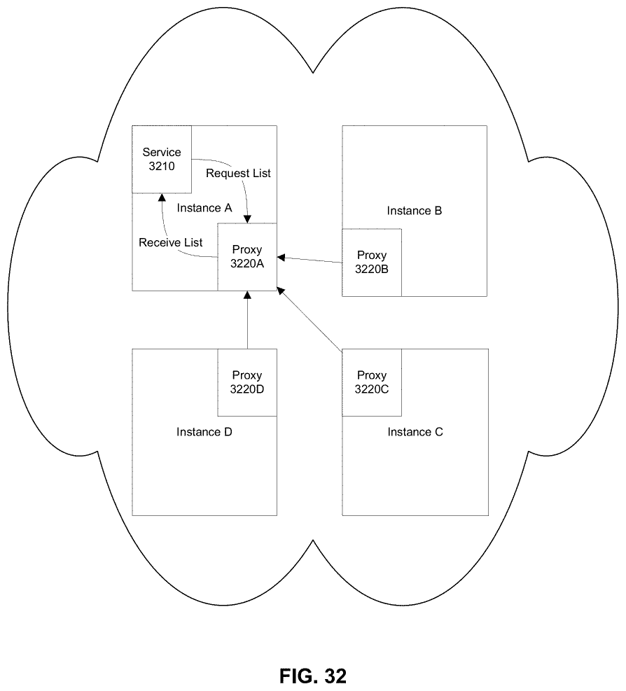

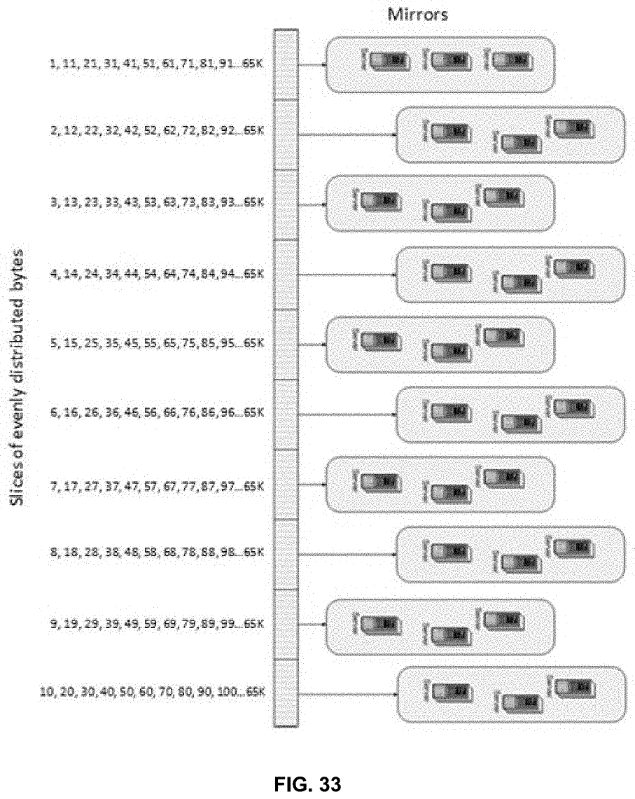

FIG. 32 is an example of routing and data aggregation using proxies. As discussed above, each service typically includes a proxy. The service component can be used by the developer to execute business logic and other data-centric functions of the cloud system. The proxy may be used to execute business logic as well, but also provide routing logic and data aggregation. In an example, cloud instance A includes a service 3210 and a proxy 3220A. When service 3210 requests a list of objects related to a set of keys, the proxy 3220A maps the set of keys with the keymap and makes requests to cloud instances B, C, and D. At cloud instance D, the proxy 3220D receives the requests for the keys (related to instance D by the keymap) and retrieves the data (e.g., via a service or directly). The proxy 3220D then aggregates the objects into a list and returns them to instance A. The same occurs for instances B and C. When all of the objects have been received at proxy 3220A, the proxy 3220A aggregates the data from the other instances B, C, D, and any objects that may reside on instance A itself. Proxy 3220A then returns a full list of the requested objects. In this way, the proxy handles the mapping of requests and the aggregation of information for the service 3210.

FIG. 33 is an example of a cartographer distribution of a keymap related to cloud instances. The cartographers and cartographer proxies provide coordination for a plurality of inter-connected processing systems for processing data. In general, the cartographer 3042 (see FIG. 30) manages the physical and logical topography of the cloud system and all its services. The cartographer 3042 also manages the distribution and redundancy for data and execution (e.g., CPU) in the form of keymaps. The cartographer 3042 enables the cloud system and administrators to create and maintain keymaps and facilitate compliance within the cloud system to the keymaps. The keymap itself is a mapping or set of distribution rules for contexts (subscriber data; e.g., artists, albums, tracks, etc.) based on keys (e.g., user IDs). The cloud system ensures every cloud instance adheres to the keymap distribution rules by moving data between cloud instances 3011 so that it is consistent with the rules. For example, if data is found on a cloud instance 3011 that it does not belong to, that data may be pushed to the appropriate instance(s) 3011 as specified by the keymap. The cartographer 3042 may push the data to other cartographers 3042 within the cloud system when a change is made to the keymap. Alternatively, a management interface may be used to update one, more than one, or all of the keymaps associated with a cloud system.

The cartographer 3042 creates and maintains keymaps within cloud groups (e.g., collections of cloud instances 3011 that are related to each other). The cartographer 3042 does this by mapping cloud instances 3011 to slices and vice versa, allowing a proxy to determine which cloud instance to communicate with to find and store data. Typically, when a request for data is submitted to the cloud system, the request contains a context and a key. As discussed above with respect to FIGS. 14 and 15, an example of a keymap transform includes a cryptographic hash that receives the key as an input and generates a hash number between 0 and 20 bytes. The generated hash number is uniformly distributed given the inherent function of the cryptographic hash system. The cartographer proxy 3042P then uses the hash number and keymap to determine which cloud instance(s) 3011 the hash number is located. When the cloud instance 3011 has been determined, the system knows which cloud instance 3011 the key is on, and thus, where to direct the proxy for that data. The cartographer proxy 3042P may also be configured to provide a communication interface for the cartographer service 3042 to communicate with the plurality of instances of cloud elements. The communication interface may include cloud awareness of all endpoints (e.g., locations on the network(s)) of the cloud instances related to each service.

The proxy may further interpret the data (keys) in uniform blocks of hash values. Each block of hash numbers has a slice assigned to it (i.e., a group of servers which all store the same information). Because crypto hashes are being used, the keys and values are evenly distributed across all Slices. Since a particular key is always on the same Slice and, in turn, on all servers that comprise the Slice, any change in the number of slices requires minimal effort to redistribute the data. As shown in FIG. 33, the uniform blocks of hash values are split into ten slices of evenly distributed bytes. Three cloud instances 3011 (each representing a mirror of the same information) resides within each slice. Thus, in this example, the redundancy is three cloud instances (and where each cloud instance is located on a different physical machine, the redundancy is three machines).

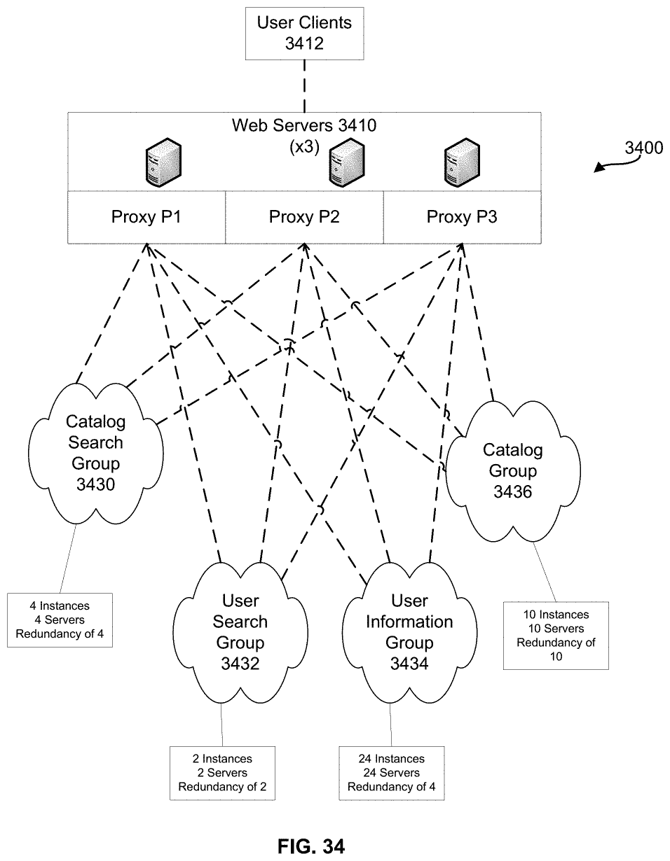

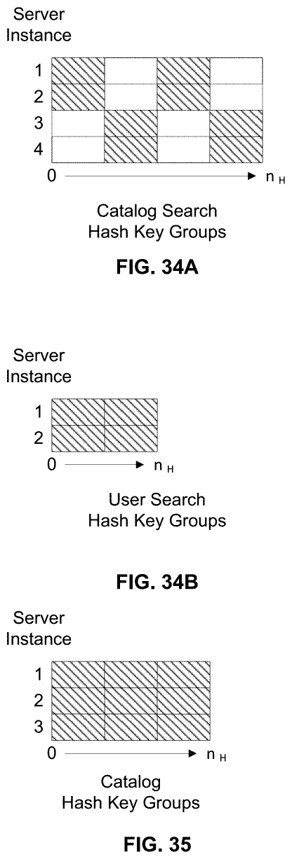

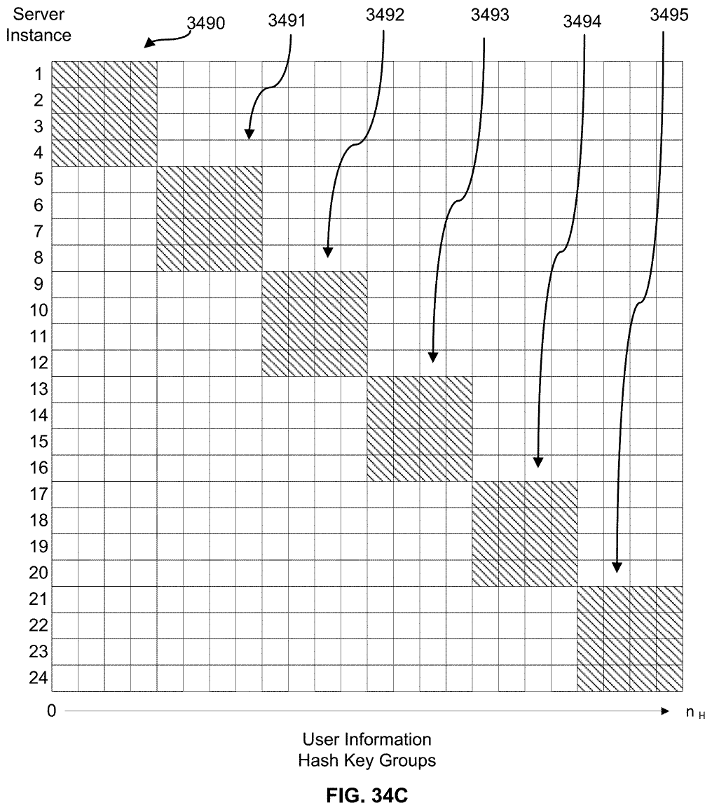

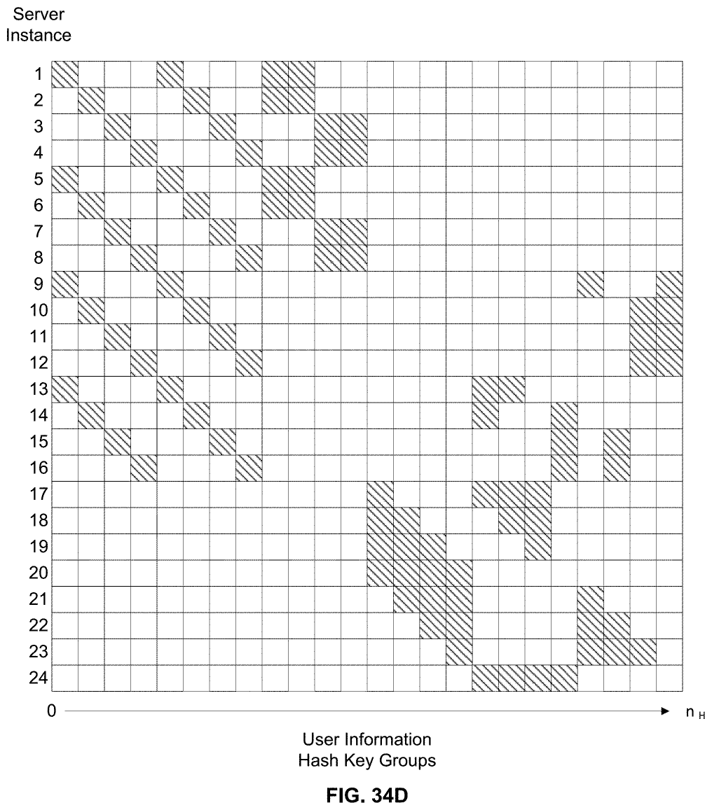

FIG. 34 is an example of a system utilizing the cloud system having separate cloud groups for specific functions. As discussed with respect to FIGS. 34 and 34A-34E, each cloud instance 3011 exists as the only cloud instance on a machine. Thus, where there exists four (4) cloud instances, we assume there are four (4) physical machines, each having a singleton cloud instance 3011.

An application 3400 uses three web servers 3410 to communicate with various user clients 3412 to receive requests and transmit responses and data. Each of the web servers 3410 includes a cloud proxy P1, P2, P3, respectively, to communicate with the cloud system that includes a catalog search group 3430, a user search group 3432, a user information group 3434 and a catalog group 3436.

As shown in this example, the catalog search group 3430 includes four (4) cloud instances 3011 (see FIG. 30) of the cloud system and each cloud instance 3011 is executed/hosted on one of four (4) physical servers. In this example, the keymap is configured for two slices. Thus, the redundancy is two (2). That is to say, the data is divided into four hash key groups and each of the hash key groups is redundantly copied to two cloud instances 3011. See also FIG. 34A.

The user search group 3432 includes two (2) cloud instances 3011 on two (2) servers. The keymap is configured for two slices. Thus, the redundancy is two (2). See also FIG. 34B.

The user information group 3434 includes twenty four (24) cloud instances 3011 on twenty four (24) servers. The keymap is configured for four slices. Thus, the redundancy is four (4) where the keymap partitions the group into six groups of redundant servers, each redundant server holding 4 copies of different information. See also FIGS. 34C-34D.

The catalog group 3436 includes three (3) cloud instances 3011 on three (3) servers. The keymap is configured for three slices. Thus, the redundancy is three (3). See also FIG. 35.

As shown, the proxies P1, P2, P3 allow the web servers to communicate with each cloud group 3430, 3432, 3434, and 3436. When information is requested, the proxy P1, P2, P3 hashes and maps (using the keymap) the request to the correct cloud instance of each cloud group 3430, 3432, 3434, 3436. Moreover, proxies P1, P2, P3 allow full access to the efficient cloud system without necessarily knowing any of the internal workings of the cloud system. In this way, the web servers may be abstracted from the data storage, processing, and retrieval. Moreover, the business logic embedded in proxies P1, P2, P3 may further reduce the complexity of the web layer.

In an example, if a user 3412 logs in, the web server 3410 will get the hash number for the particular user. The web server may initiate a session that may be stored in the user information group 3434 that also may include the detailed information about the user and their history. When the user updates their information the web layer passes that information to the user information group 3434 and the proxy P1, P2, P3 automatically sends that information to the correct slices.

Similarly, if a web request is received for a catalog item, the proxies P1, P2, P3 may request the catalog item from the catalog group 3436. The catalog item may be hashed by, for example, the catalog item number. The proxy may also verify whether the requester is authorized to access the catalog item, and if not, reject the request.

Similarly, the system allows for a catalog search where the search may be performed by the catalog search group 3430 and wherein the proxies P1, P2, P3 aggregate the results into a unified result. Separately, the user may also perform searches on a separate user search group 3432.

By separating the functionality of the application into multiple groups, the redundancy, physical server load, and other metrics may be optimized. For example, when dealing with user information, a high level of logging may be required that adds stress to the physical machines in that group. Thus, the number of slices may be expanded and the redundancy may be adjusted to minimize resource contention. However, for search-related applications, the redundancy may be fully utilized where the logging levels are at a minimum, but high availability is desired.

FIG. 34A is an example of the keymap for the catalog search. As shown, the keymap is divided into four (4) hash key groups (see the bottom legend) and four (4) server instances (see the left vertical legend). The redundancy is determined by the keymap to be two (2). Thus there are two (2) groups of redundant instances as provided by this keymap.

FIG. 34B is an example of the keymap for the user search. As shown, the keymap is divided into two (2) hash key groups (see the bottom legend) and two (2) server instances (see the left vertical legend). The redundancy is determined by the keymap to be two (2). Thus, the data will be redundantly copied to each of the instances.

FIG. 34C is an example of the keymap for the user information. As shown, the keymap is divided into twenty four (24) hash key groups (see the bottom legend) and twenty four (24) server instances (see the left vertical legend). This is an example of how the keymap may be used with a non-even number of instances. Note that the number of hash key groups does not necessarily have to match the number of server instances. The redundancy is determined by the keymap to be two (3). Thus, the data will be redundantly copied to each of the instances.

FIG. 34D is an example of an alternative keymap for the user information. As shown, the keymap distribution is non-patterned as is shown with the keymaps of FIGS. 34A and 34C. However, the distribution and redundancy rules are still met by the keymap of FIG. 34D. This demonstrates that the keymap may be modified or originated with any pattern so long as the redundancy requirements are adhered to.

FIG. 35 is an example of the keymap for the catalog. As shown, the keymap is divided into three (3) hash key groups (see the bottom legend) and three (3) server instances (see the left vertical legend). This is an example of how the keymap may be used with a non-even number of instances. Note that the number of hash key groups does not necessarily have to match the number of server instances. The redundancy is determined by the keymap to be three (3). Thus, the data will be redundantly copied to each of the instances.

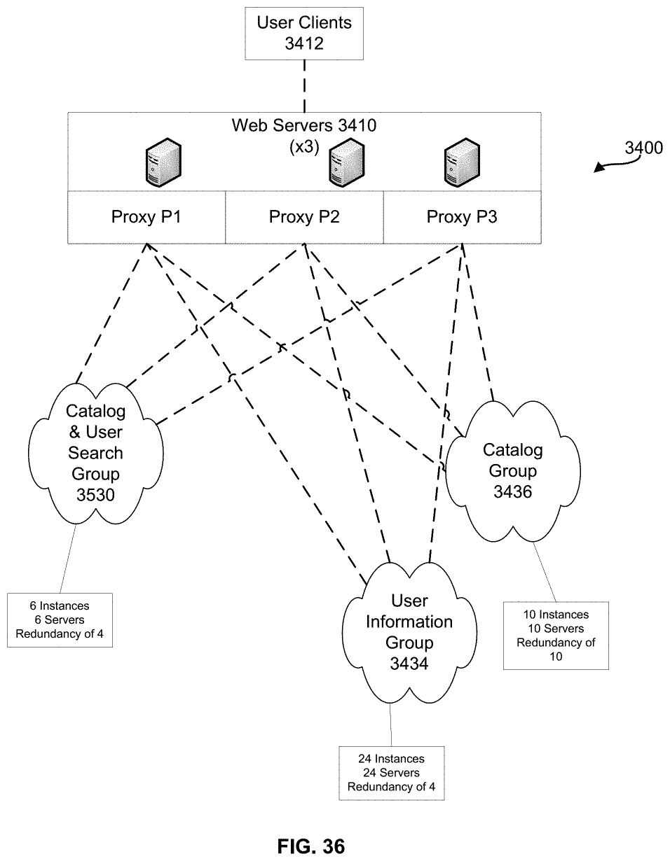

FIG. 36 is an example of a system utilizing the cloud system having shared cloud groups for specific functions. Here, there may be more than one cloud instance 3011 per machine. This may be used to leverage hardware resources but, depending on the hardware capabilities, may sacrifice throughput. In this example, the catalog search group 3430 (of FIG. 34) and user search group 3432 (of FIG. 34) are combined into a catalog and user search group 3530. The combination is a hardware-sharing combination where each of the catalog search group and the user search group has its own context. However, the keymap facilitates sharing of the hardware resources.

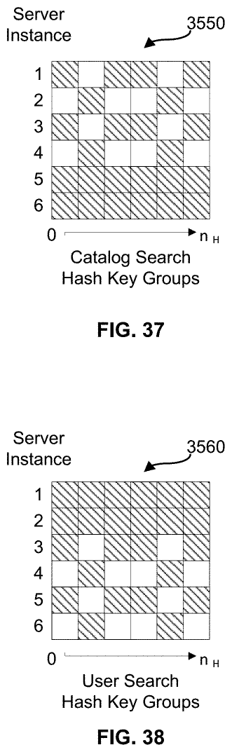

FIG. 37 shows an example for the catalog search group keymap 3550, wherein there are six (6) instances, six (6) servers, and a redundancy of four (4).

Similarly, FIG. 38 shows an example for the user search group keymap 3560, wherein there are six (6) instances, six (6) servers, and a redundancy of four (4).

By comparing the keymaps of FIGS. 36 and 37, certain of the server instances are assigned more hash key groups than others when the aggregate of both the catalog search group keymap 3550 and the user search group keymap 3560 are taken in aggregate. For example, server instance 1 (mapped to a physical server) includes four slices from catalog search group keymap 3550 and six slices from user search group keymap 3560, totaling ten slices on a single instance. This is the same for server instances 2, 5 and 6. However, server instances 3 and 4 include only four slices for each instance. This means that given a distributed mapping, instances 1, 2, 5 and 6 are going to be worked more than twice as hard as slices 3 and 4. While the hardware may be able to keep up with the increased load, the keymaps could be adjusted to allow for a more even distribution of workload.

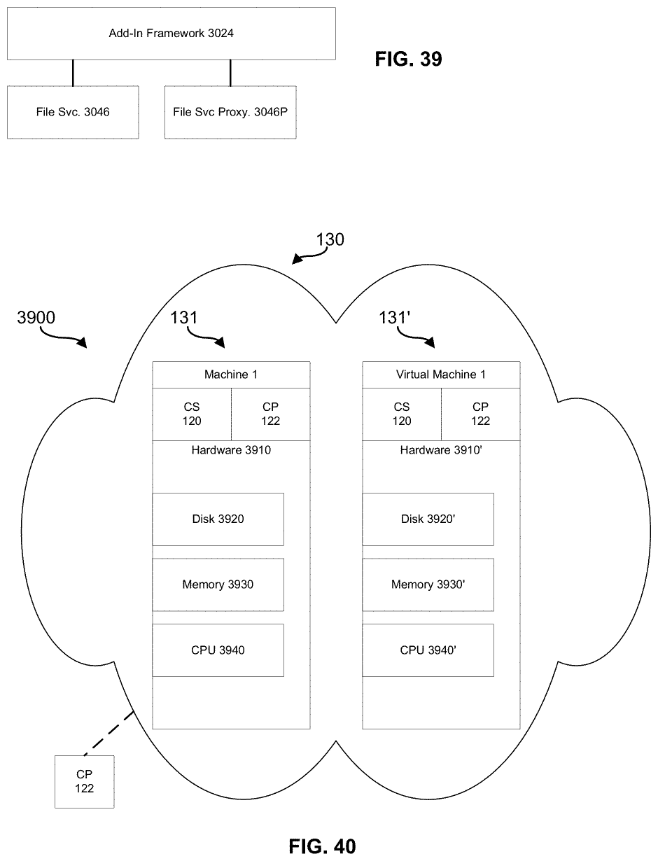

FIG. 39 is an example of a file system add-in for use with the system for cloud computing (see also FIG. 30 for additional detail). FIG. 40 is an example of the file system having access to local machine resources including a Cloud Hardware Configuration 3910 for cloud machines 131 as used in cloud 130. Each physical machine (e.g., cloud machine 131) may include disk resources 3920, memory resources 3930, and CPU resources 3940, among others. The hardware resources may be local or distributed by way of their configuration.

Disk resources 3920 may be a local direct attached storage, such as a hard-disk (e.g., Serial Advanced Technology Attachment or “SATA”, Small Computer System Interface or “SCSI”, Serial Attached SCSI or “SAS”, Fibre Channel, etc.) but may also include specialized storage devices such as a fast Solid State Drives (SSD) or Ram Disk. The selection of the disk resource 3920 may be based on the requirements for speed or based on the ability to process large numbers of operations in a highly transactional environment. The Disk 3920 may include a non-local storage system such as a Storage Attached Network (SAN) or Network Attached Storage (NAS). It is contemplated that Disk 3920 may include one or more of the aforementioned storage architectures, depending upon the system requirements. Each of the local resources may be mapped together, or separately via a keymap. In this way, the cloud 130 may treat the disk resources 3920 individually based on the performance and redundancy requirements. In addition, the disk resources 3920 may include access to alternative cloud-based storage networks that may reside outside of cloud 130.

Memory resources 3930 may include the amount of Random Access Memory (RAM) in a system. The memory resources 3930 may be used as a constraint when developing keymaps based on the expected memory resources 3930 usage in operation. Moreover, based on other functionality of cloud 130, certain cloud machines 131 may be provided with additional memory resources 3930 when they are configured to have other resources operating on them, such as a distributed cache, which may not be operating on all hardware participating in cloud 130.

CPU resources 3940 may include the number of CPU's or “cores” per machine as a resource for scalability and take into account the transaction and processing load required for the system. In this way, machines with more CPU resources may be able to operate with higher overall load than machines having less CPU resources. In general, the CPU resource may include both the number of “cores” as well as the relative speed of each core. Thus, the determination of a CPU resource for a machine may include both the number of cores and their speed. For example, a machine with 4 cores, each operating at 1.6 GHz, may be assigned a CPU score of 4 times 1.6, or 6.4. This may contrast with an 8 core machine, each operating at 2 GHz, which is assigned a CPU score of 16 (8 times 2). By scoring, or benchmarking, each machine's CPU resource, the keymap may be adjusted or optimized for each machine based on the amount of CPU resource expected in operation.

By identifying each resource and quantifying it (e.g., disk, memory, CPU), they may be bound together using keymaps and further distributed for redundancy, with a high degree of liquidity of action. This further provides that the CPU utilization on the data (stored on disk) can be mapped to be local such that more processing occurs within the machine 131 rather than requiring significant transmission of data over the network. This reduces network load and further drastically improves performance when data and CPU are localized.

Additionally, as cloud 130 may be abstracted to operate on virtual systems that may use virtual devices, a virtual cloud machine 131′ may include disk resources 3920′, memory resources 3930′, and CPU resources 3940′, among others, that have unknown physical hardware attributes. These resources may be reported as available, but may not represent the physical hardware available at the machine level. Such instances may be provided on-demand or available ala-carte when needed. An example of virtual usage may include high-transactional periods where additional capability is necessary over a short-term period. However, the system may be configured to operate with a generic cloud-provider platform as standard. In this way, the cloud 130 may be scaled or moved as desired with minimal hardware management.

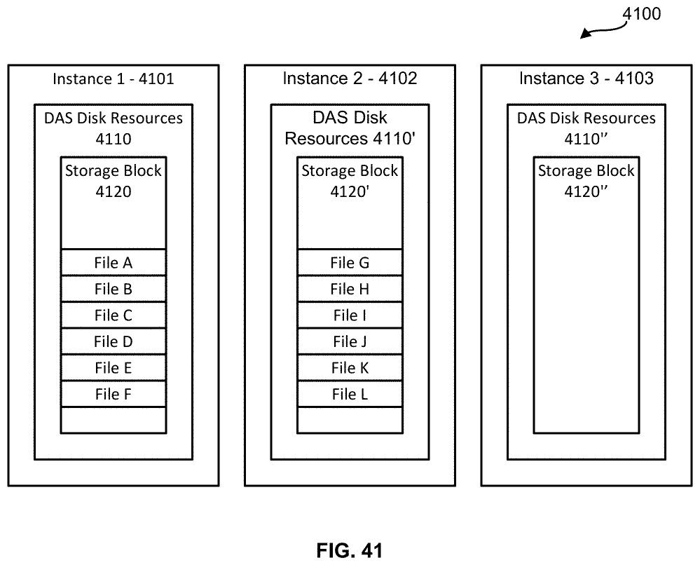

FIG. 41 is an example of two file system blocks having data before reallocating data to a third file system block. The operating system independent file system may use a variety of native file systems, including but not limited to, NTFS, ZFS, FAT, ext4, etc. The choice of file system may be based on the operating system used, the capacity required, and the relative throughput (read/write) required. A first instance 4101 of a cloud system, and more particularly, a file system instance, a second instance 4102, and a third instance 4103 are shown in communication via the cloud system. Each file system instance 4101, 4102, 4103 includes Direct Attached Storage (DAS) disk resources 4110, 4110′, 4110″, respectively. Each disk resource has access to storage blocks 4120, 4120′, 4120″, respectively. As discussed herein, the instances may be executed on separate physical machines having separate hardware, or they may be executed in whole or in part on the same machines and share physical hardware. However, for redundancy purposes, the keymaps (as discussed herein) should take into account the storage reliability and redundancy requirements to prevent shared hardware when redundancy is required.

The DAS disk resources 4110, 4110′, 4110″ may be embodied as, for example, SCSI, SATA, IDE, Flash Drives, etc., that provide persistent storage. Alternatively, the DAS disk resources 4110, 4110′, 4110″ may be embodied as NAS or SAN resources. However, for simplicity, they will be referred to herein as DAS disk resources. The speed, capacity, and endurance of the DAS disk resources may be decided by the design requirements. For example, high write frequency may lend itself to electro-mechanical storage media such as a hard-disk. Alternatively, high transactional frequency may lend itself to Flash-based storage.

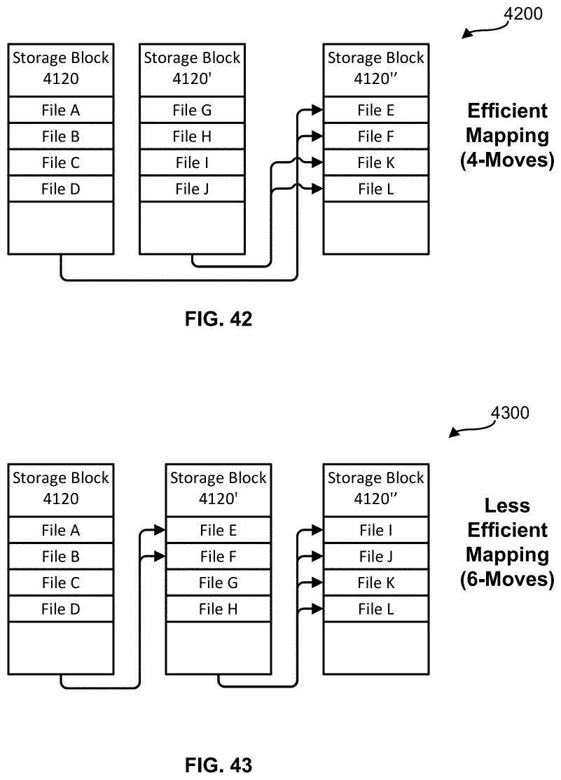

As shown, storage block 4120 (of first instance 4101) includes files A, B, C, D, E, and F. Storage block 4120′ (of second instance 4102) includes files G, H, I, J, K, and L. Storage block 4120″ (of third instance 4103) is empty. These storage blocks and files will be used as examples with respect to FIGS. 42-46.

FIG. 42 is an example of an efficient data transfer scheme based on a keymap update. When time or speed of a keymap update is desired, the data being transferred from one storage block (e.g., storage block 4120) to another may be the greatest constraint. Because the storage blocks (e.g., storage blocks 4120, 4120′, 4120″) may be on different machines for redundancy requirements, the data may need to be transferred from one disk, over a network, to another disk. The time delay created may include the read time, write time, processing time, and network delays. Moreover, CPU resources and memory may be used during the transfer process that decreases the capability of the machines in use. To reduce time and resource consumption, the keymap may be elegantly modified to provide the minimum amount of data transfer. As shown in FIG. 42, the files E and F are transferred from storage block 4120 to storage block 4120″. In this way, the file load can be shared from two storage blocks to three storage blocks with a minimum amount of data transfer. This results in a total of four (4) storage moves based on sharding the data from 2 slices to 3 slices.

FIG. 43 is an example of an alternative data transfer scheme based on a keymap update. A less efficient keymap change can result in moving more files than necessary between storage blocks. In this example, files E and F are moved from storage block 4120 to storage block 4120′. Then, files I, J, K, and L are moved from storage block 4120′ to storage block 4120″. This results in a total of six (6) storage moves based on sharding the data from 2 slices to 3 slices. As compared to the method used in FIG. 42, the inefficient shift may cause a burden on the hardware as well as delaying completion of the keymap update. While shown here with a small number of files, the time to move large numbers of files may be dramatic.

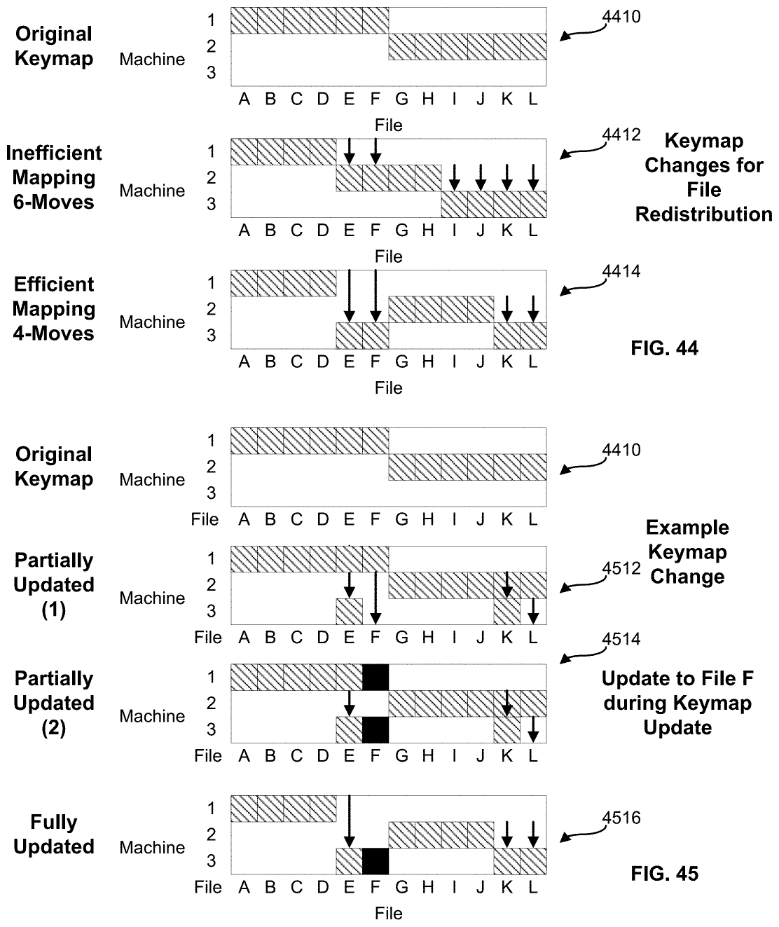

FIG. 44 is an example of data transfer based on a keymap update as related to FIGS. 41-43. Original keymap 4410 shows the initial configuration of the files (A-L) on machines (1-3). During the inefficient re-mapping scenario of FIG. 43 (above), map 4412 the files E and F are moved from machine 1 to machine 2 (resulting in two moves). The files I, J, K, L are moved from machine 2 to machine 3 (resulting in 4 more moves). Thus, the total number of moves becomes (6) in this scenario. Map 4414 shows the moves from machine 1 and machine 2, both directly to machine 3. By re-mapping to move the minimum number of files, the two (2) to three (3) shard mapping is accomplished with just four (4) moves. As the keymap may be modified in any way, the remapping may be done as shown in this simple case, but it may also be done on tens, hundreds, or more, file storage blocks.

FIG. 45 is an example of an update sequence when a keymap update and data transfer is underway. Using the efficient keymap update strategy 4414 of FIG. 44, there occurs updates when operating on live data during a keymap update. Unless a system is to be “taken down” during an update, a live system has to handle modifications to the data on the fly. Shown in map 4512, files E and F are to be transferred from machine 1 to machine 3, and files K and L are to be transferred from machine 2 to machine 3. Map 4512 shows transfers to files E and K having happened. However, map 4514 shows a modification to file F during the keymap update process. In this case, while operating on live data, the data is written to both machines 1 and 3. This provides the error recovery necessary if the keymap update is not successful so that both locations (on machines 1 and 3) have the new data. Map 4516 shows the completion of the keymap update. When the keymap update is complete the original data for files E, F, K, L may be deleted from their source (machines 1 and 2) after the keymap update is accepted. As shown, even the new data for file F is deleted from machine 1 once the keymap update is successful.

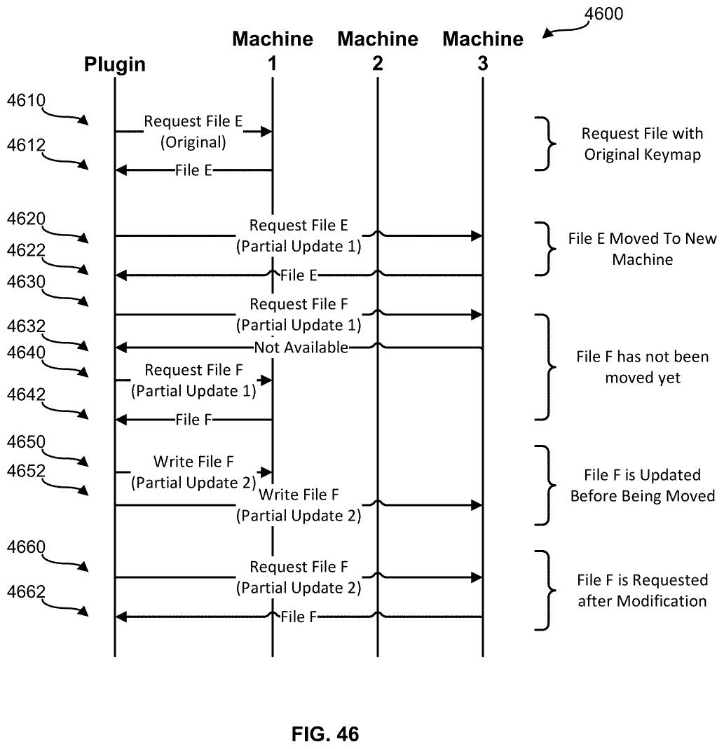

FIG. 46 is an example sequence diagram of the data transfer when a keymap update is underway. In step 4610 a plugin requests file E. The keymap is the original keymap and the request is routed to machine 1. Note that the plugin making the request may be any plugin in the namespace of the cloud system. The plugin could also be replaced by a proxy or a service in the cloud system.

In step 4612, the file is returned by machine 1. Note that the request was mapped to machine 1 by the keymap and the hash of the file being requested (file E).

In step 4620, file E has been moved to machine 3 (see map 4512 of FIG. 45). Based on the remapping being in process, the request is mapped to the new location (machine 3). The logic on-the-fly mapping during updates is shown in FIGS. 48-49.

In step 4622, the file is returned by machine 3 under the partially updated keymap strategy 4514 shown in FIG. 45.

In step 4630, a request for file F is made to the new keymap location (machine 3). However, as shown in partially updated keymap strategy 4514, file F has not yet been moved to machine 3.

In step 4632, machine 3 indicates that file F is not available.

In step 4640, the plugin requests the file from machine 1 because file F was not available from machine 3. Under the update strategy, the final machine is queried first, then the existing machine is queried if the file has not yet been moved. This provides that the system does not have to maintain globally available lists of location/status during a keymap update.

In step 4642, file F is returned by machine 1.

In step 4650, the plugin writes file F. Because the keymap is being updated, the file may be written to more than one keymap location. In this example, the file F is written to machine 1 (the old location).

In step 4652, after or in parallel with, step 4650, file F is written to machine 3 (the new location). This maintains consistency of new and old locations for file F under the keymap update.

In step 4660, a read is made for file F. The request is mapped to machine 3.

In step 4662, file F is returned from machine 3. This is in contrast to step 4632 where file F was not available at machine 3. However, due to the write at step 4652, file F becomes available and the plugin need not request the file from another source once file F is received.

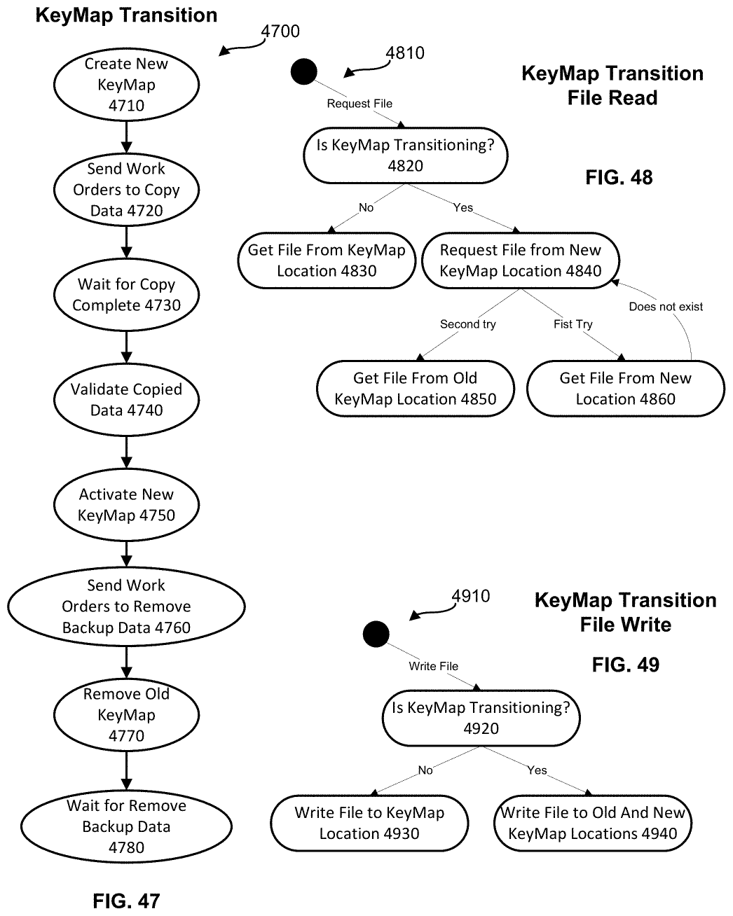

FIG. 47 is an example of a flow diagram 4700 for updating a keymap using a workorder. As discussed herein, the workorder system is a distributed system for carrying out tasks for the cloud system internally, or for use by plugins to provide logical jobs to be distributed to appropriate instances. In this case, the workorder system is used by the cloud system to update the keymap, initiate the data transfer according to the keymap update, and then transition to the new keymap when complete.

In step 4710, a new keymap is created. The keymap may be created by an administrator, loaded into the system from an external source, or automatically generated by the cloud system based on criteria for information processing and data distribution. In general, keymaps may be updated to change the distribution of data, change the hash mapping (generally), and may be updated when new hardware is added to distribute the storage and processing of the cloud system.

In step 4720, the cartographer service 3042 and cartographer proxy 3042P (see FIG. 30) may be used to initiate the new keymap distribution. They cartographer proxy 3042P may communicate with the work order service 3043 through the various work order proxies 3043P at each instance of the cloud 3011 (see FIG. 30). In this way, the work order service 3043 can manage the updating of information at each cloud instance 3011. When the work order service 3043 receives the instructions to update the cloud instance 3011 with a new keymap, the data transfer may be choreographed using additional work orders. For example, if data needs to be transferred from one cloud instance 3011 to another 3011′, then the work order may initiate transfer of the data. This may be file system data (as discussed above with respect to FIGS. 41-49) or it may be other data such as cache data, database data or other data that may reside with other services on that cloud instance 3011. The work order may be tailored to be a push or a pull system. On a push system, the data transfer is initiated from the originator to the receiver. In a pull system, the receiver requests the data.

In step 4730, the work order service 3043 may continue transferring data and waiting for all data transfers to take place.

In step 4740, the system may validate the data. This may be accomplished by checksum comparison of the information or using byte-by-byte comparison (although costly).

In step 4750, when the data transfer is complete and when verification is complete (if desired), the cartographer service 3042 may transition the cloud instance 3011 to the new keymap.

In step 4760, the work order service 3043 may queue jobs to remove the undesired duplicate data from the system.

In step 4770, the old keymap may be removed from the system. However, the cloud system may wish to maintain older copies of the keymap in case the administrator wishes to roll-back to an earlier keymap.

In step 4780, the system waits for the undesired data to be removed and the process completes.

FIG. 48 is an example of a state diagram for requesting a file using the file system. When a read is requested 4810, the system determines 4820 whether a keymap is in transition. If the keymap is not in transition, the routing is identified 4830 as the existing keymap location and a request is sent for the data. If the keymap is in transition 4840, the system first attempts 4680 from the new keymap location. If the file exists at the new keymap location the process ends when the file is received. However, if the file does not exist at the new keymap location the system reverts to the old keymap location 4850. In this case, the process ends when the file is received from the old keymap location.

FIG. 49 is an example of a state diagram for writing a file using the file system. In step 4910 a write is initiated. The proxy determines if a keymap is in a state of transition 4920. If the keymap is not transitioning, the file is written to the keymap location 4930. If the keymap is transitioning, the file is written to both the old and the new keymap locations 4940 (see also FIG. 45, map 4514).

FIGS. 50-84 are an example of a cloud computing administrator system that may be used with cloud management and deployment system 2900 of FIG. 29. The cloud computing administrator may be used for managing resources, deploying services, and optimizing resources in the cloud. The administrator accesses the system through a user interface that may be a network interface (e.g., for use over a network such as the Internet) or a local program interface (e.g., a program that operates on the Windows®, or other, operating system).

FIG. 50 is a login screen where a user can access the cloud computing administrator. The login may be located on any network, such as a WAN or LAN. The administrator may access the cloud computing system using an access proxy.

FIG. 51 shows “all environments” of the cloud. The administrator may view the existing cloud environments and their general information such as number of servers deployed, RAM memory, disk space, CPU resources, and the number of plug-ins deployed. The all environments display may also show unaffiliated servers, with their general information, which have not been assigned to a particular cloud. In this example, the administrator has the options for “Create New Environment”, environments “Example Staging”, “Music Staging”, “Music Dev”, “Unaffiliated Servers”, and “Example Dev”.

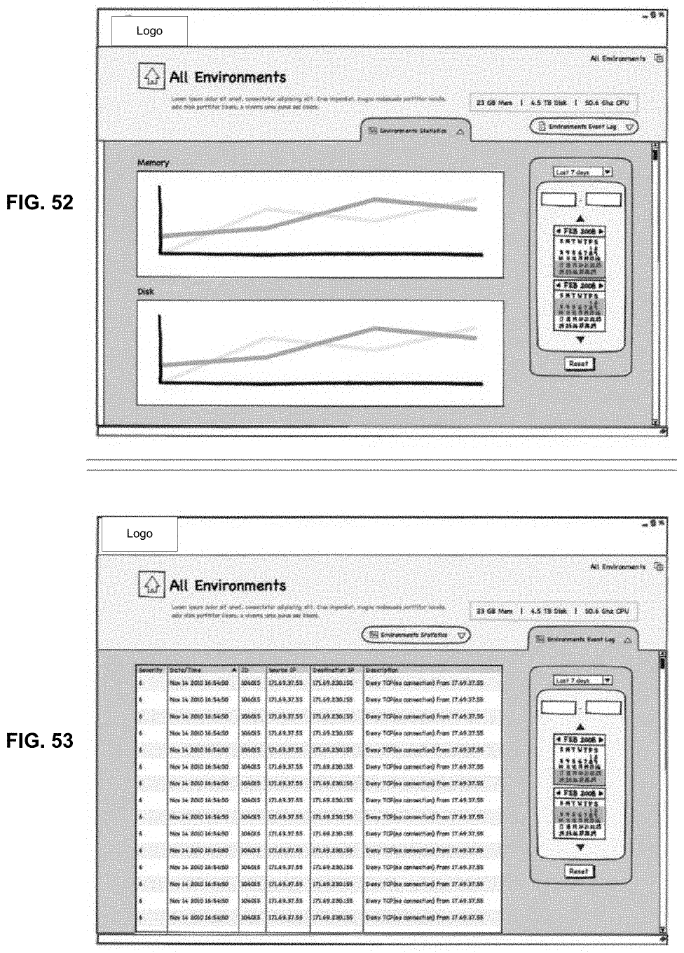

FIG. 52 shows an “all environments” statistics tab that provides the cloud statistics information. This may include general information about the cloud including disk, memory and CPU utilization. The term of the statistical overview may be modified, for example, by a date/time range. Other information may also be shown such as network utilization/congestion, total bandwidth in/out of the cloud and/or within the cloud etc.

FIG. 53 shows an “all environments” events log which provides the cloud events log. The log may serve to show errors within the cloud that may require corrective action, or indicate a problem. The range of the log may be modified, for example, by a date/time range.

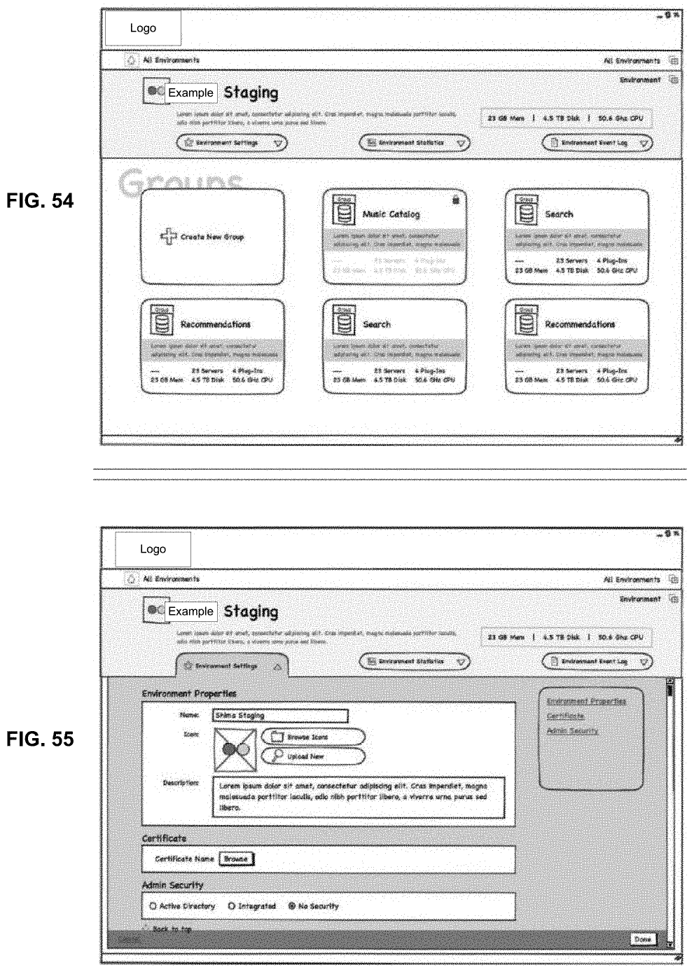

FIG. 54 shows an example of an environment, in this case called “Example Staging”. The environment may include multiple groups. Each group may perform a function or be duplicated functions, such as “Music Catalog”, “Search” (two shown), and “Recommendations” (two shown). The administrator may also create new groups for the environment.

FIG. 55 shows an example of an environment's settings. The environment may include properties such as the name, icon, and description. The environment may also include a certificate (e.g., for authentication). The environment settings may include administrative security options (in this case as used with a Windows authentication for .Net/ASP) such as Active Directory, Integrated, or No Security (see also FIG. 59).

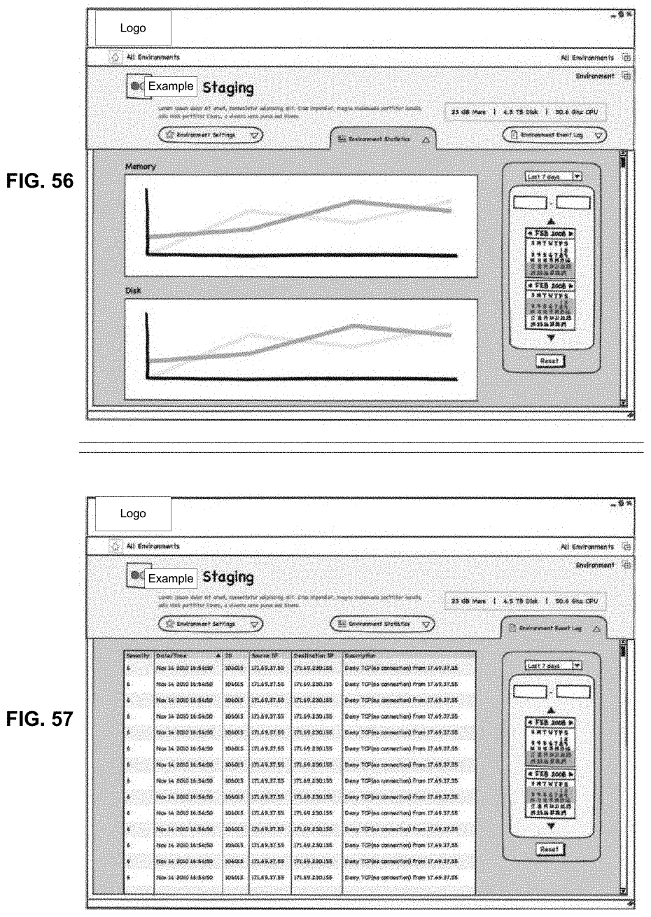

FIG. 56 shows an environment statistics panel, similar to that shown in FIG. 52, but is relevant to the environment (in this case Example Staging) rather than the entire cloud. The hierarchical system provides the administrator the option to view statistics at the level of granularity desired. Where the administrator desires to see the cloud statistics, they may proceed to the page shown in FIG. 52. When the administrator desires to see a particular environment's statistics, they may browse to the environment and find the statistics for that environment.

FIG. 57 shows an example of an environment event log. The log may serve to show errors within the environment that may require corrective action, or indicate a problem. The range of the log may be modified, for example, by a date/time range.

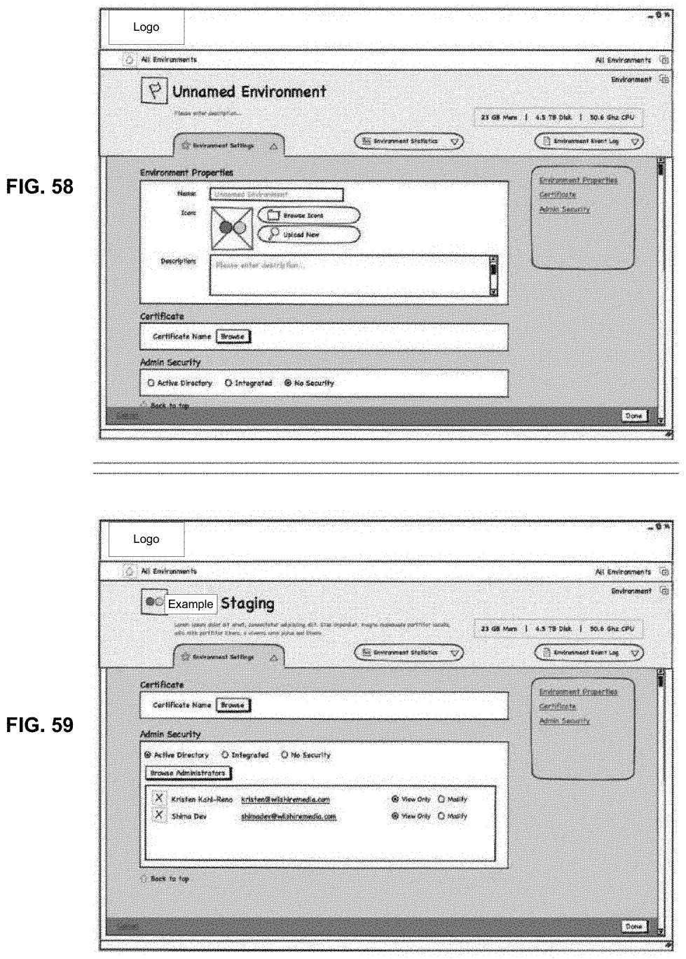

FIG. 58 shows a new environment from FIG. 51's “Create New Environment” button. Initially, the environment is an “unnamed environment” until the administrator provides a name. Environment properties, certificates and administrative security are available for configuration. The staging phase may be where an environment is being configured but not yet deployed for use.

FIG. 59 shows the new environment setup for Active Directory security including two developers having “view only” access. The administrator may setup security based on different strategies. One strategy may be Microsoft Windows Active Directory (“AD”). Another may be Microsoft Windows integrated security, or there may be no security at all. In this way, the administrator may customize the security for an environment.

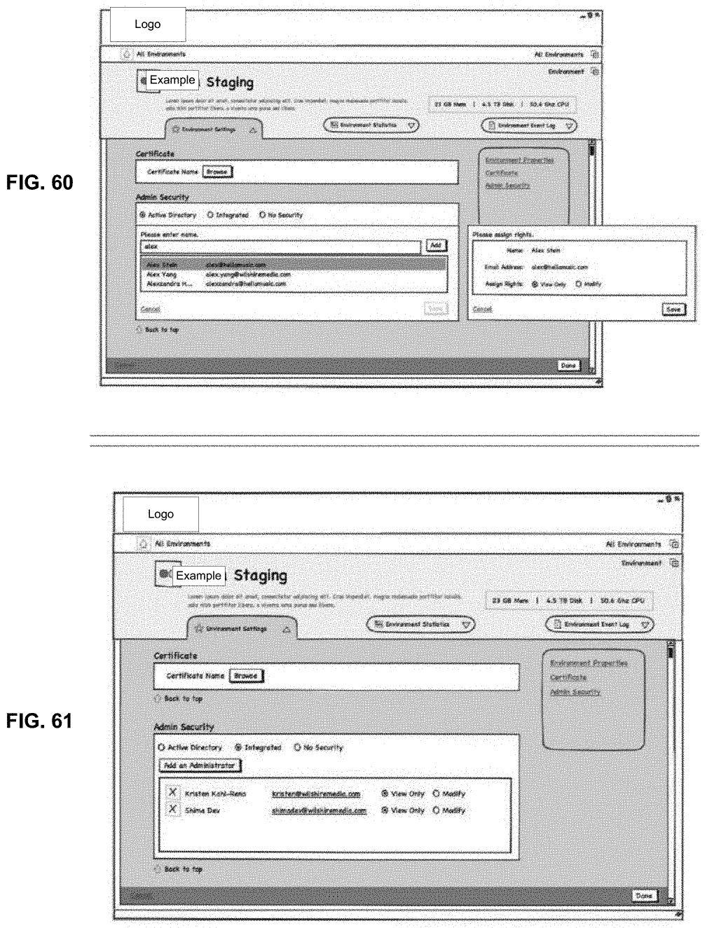

FIG. 60 shows the new environment with selection of an administrator from the Active Directory list.

FIG. 61 shows the administrator security setup for integrated security.

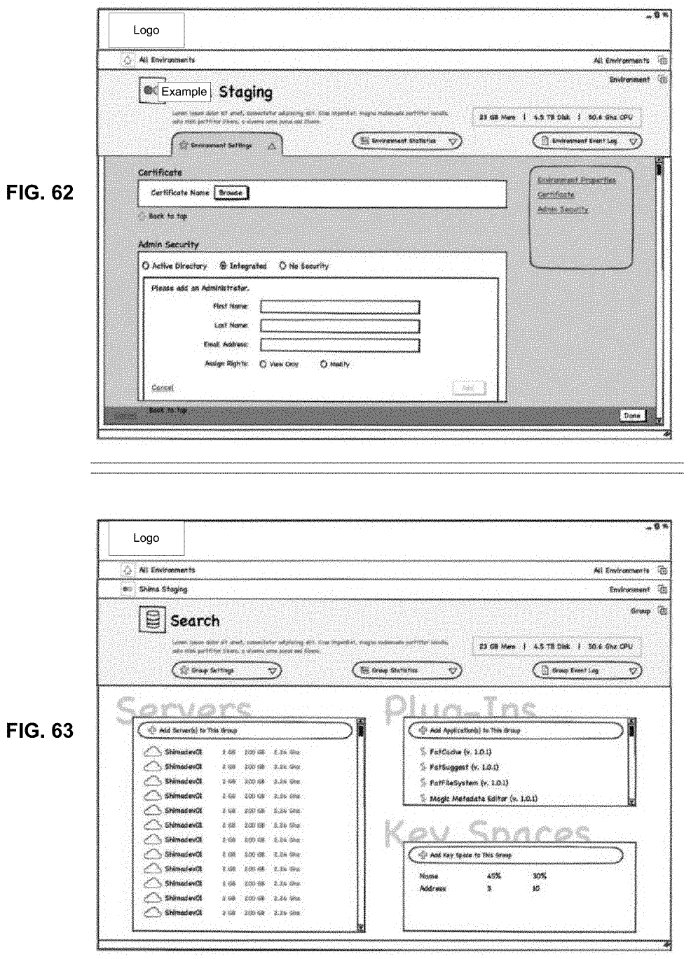

FIG. 62 shows the administrator security setup for integrated security having manual fill-in information for each administrator.

FIG. 63 shows an administrator search of servers, plug-ins and key spaces in a cloud. Using the search function, the administrator may locate servers and/or services that are available for use with the environment.

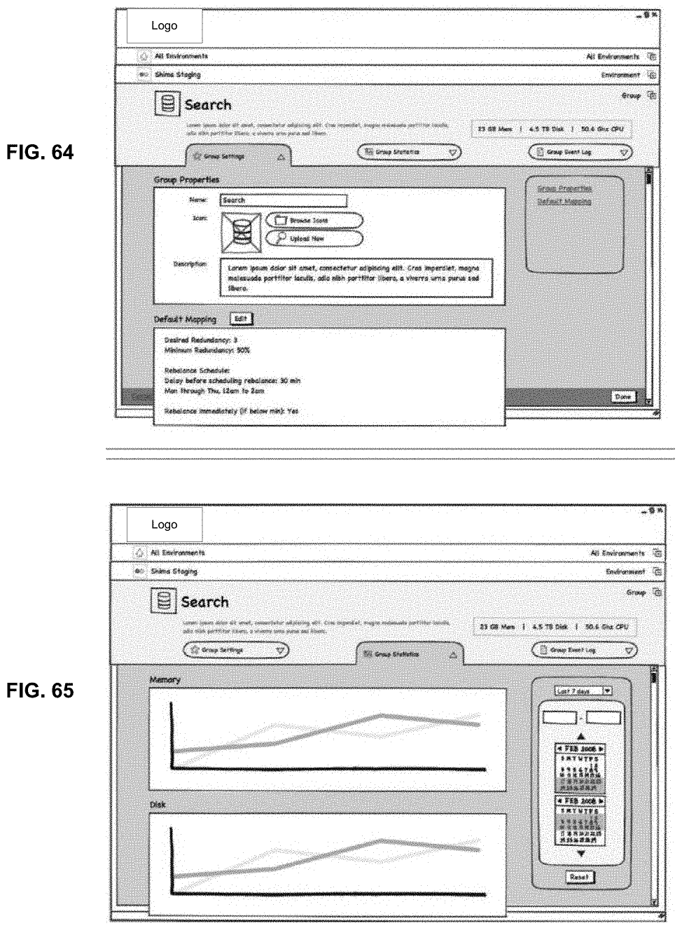

FIG. 64 shows a group setting for a search application, the default mapping, desired redundancy, minimum redundancy, and other parameters may be input. For example, rebalancing of the data may only be done Monday through Thursday from 12 am to 2 am.

FIG. 65 shows a group's statistics. The administrator can use the calendar (see right) to set the date range for statistical display, and then admire the metrics. Common statistics shown may include memory usage and disk consumption. However, other performance parameters may also be provided.

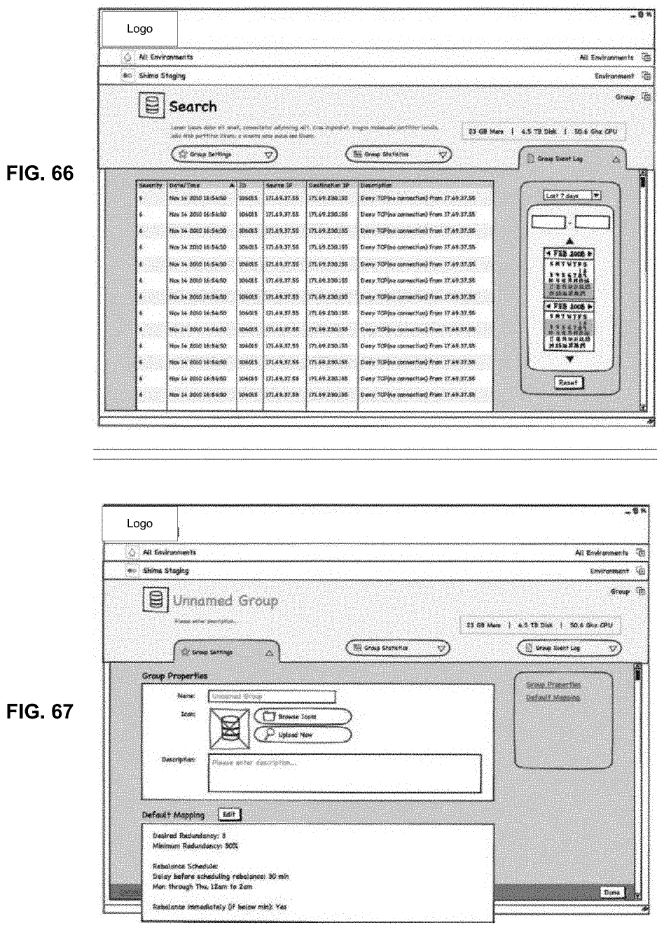

FIG. 66 shows a group event log. The administrator can set the date range (at right) and view the log entries for that time period to verify actions take in the cloud, or to determine the cause of a problem.

FIG. 67 shows a basic group setting entry window.

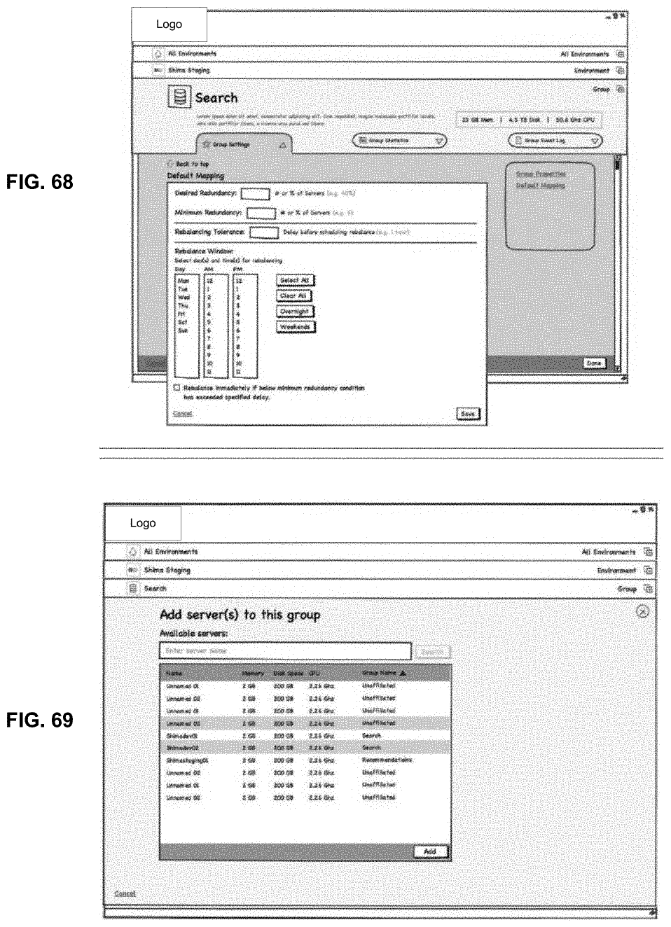

FIG. 68 shows a mapping for a group. The default mapping may include desired redundancy, minimum redundancy, tolerance, and rebalance windows.

FIG. 69 shows an add server entry window where the servers are listed and can be selected for addition to the group.

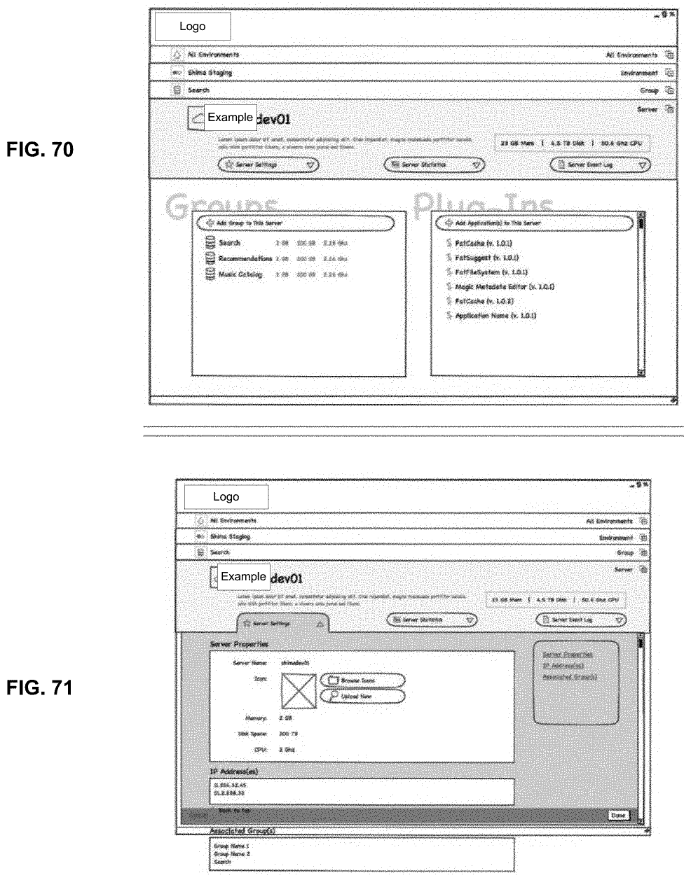

FIG. 70 shows a server configuration window allowing the administrator to add groups, add applications, and add plug-ins to the server.

FIG. 71 shows a server setting entry window including the server name, IP addresses, and associated group.

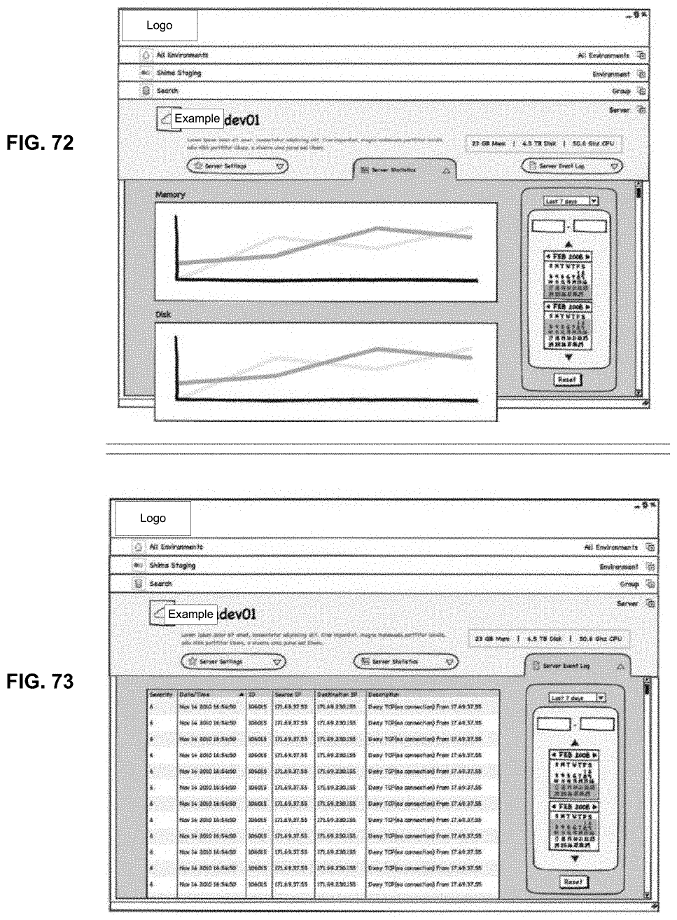

FIG. 72 shows a group statistics windows that shows memory and disk utilization across an entire group.

FIG. 73 shows a group event log.

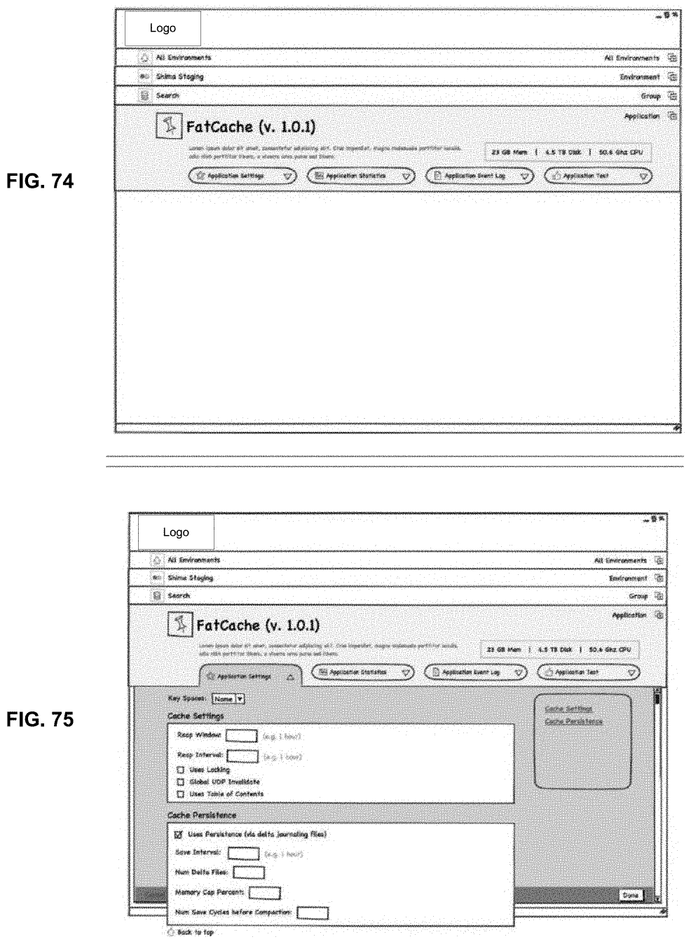

FIG. 74 shows a home page for an application run under a group. The administrator can choose to adjust the plug-in settings, check plug-in statistics, view the plug-in event log, and test the application.

FIG. 75 shows the plug-in settings view, where various parameters for a cache application can be fine-tuned.

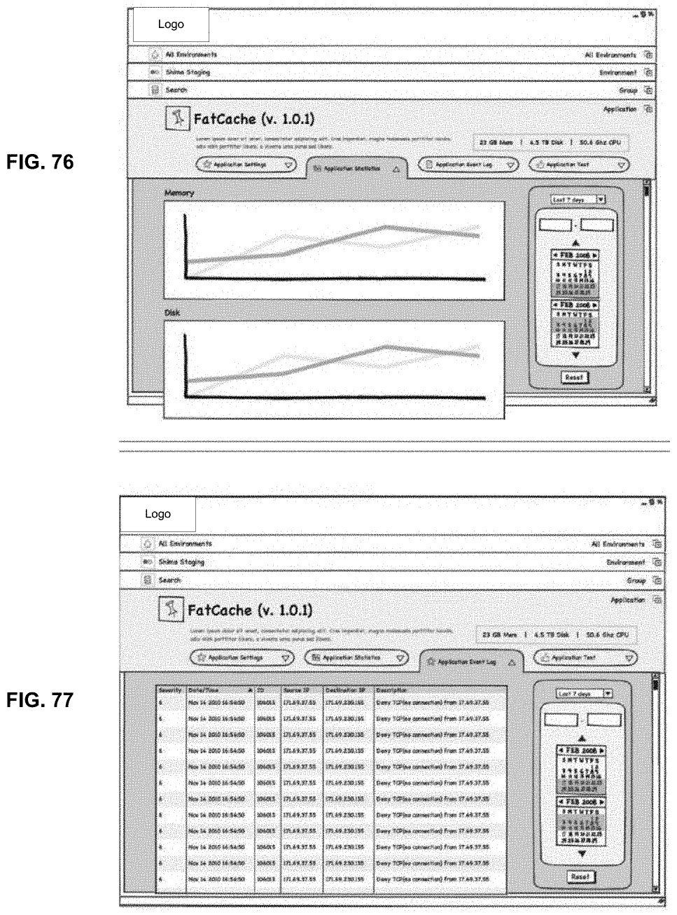

FIG. 76 shows statistics for the plug-in including memory and disc consumption.

FIG. 77 shows the event log for the cache system.

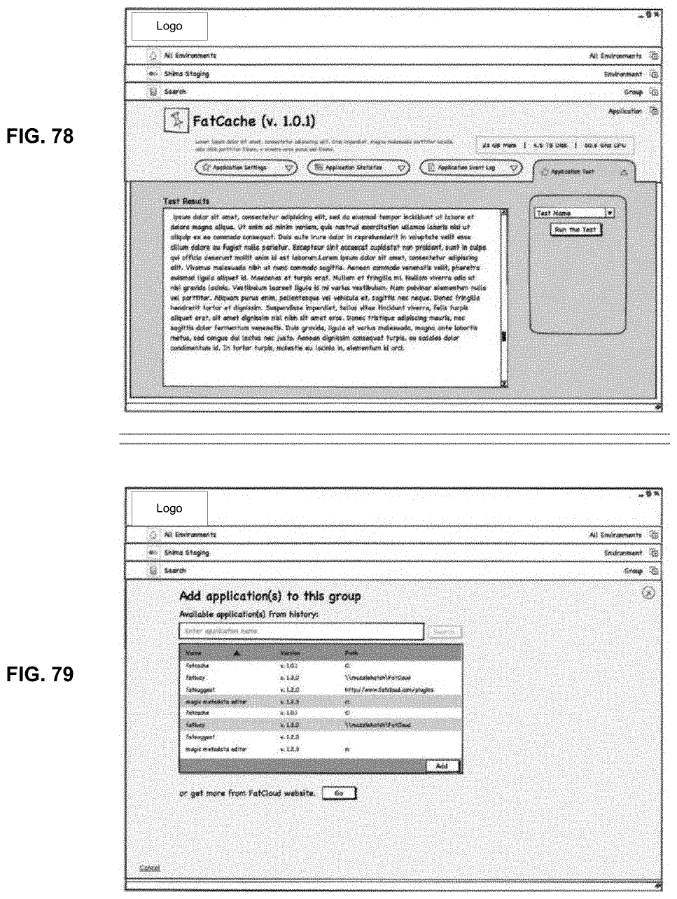

FIG. 78 shows a test screen for the plug-in.

FIG. 79 shows the dialog box to add various plug-ins to a group, their location, and version information.

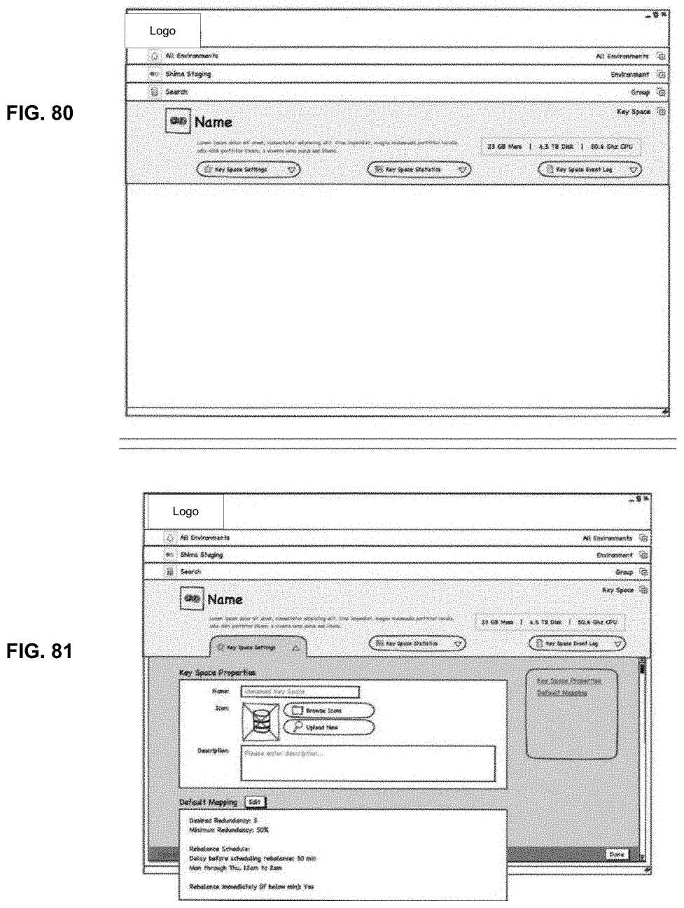

FIG. 80 shows a key space mapping. The key space mapping allows for key space settings, key space statistics, and key space event log.

FIG. 81 shows the key space settings having a desired redundancy of 3 and a minimum redundancy of 50%. Rebalancing may also be indicated.

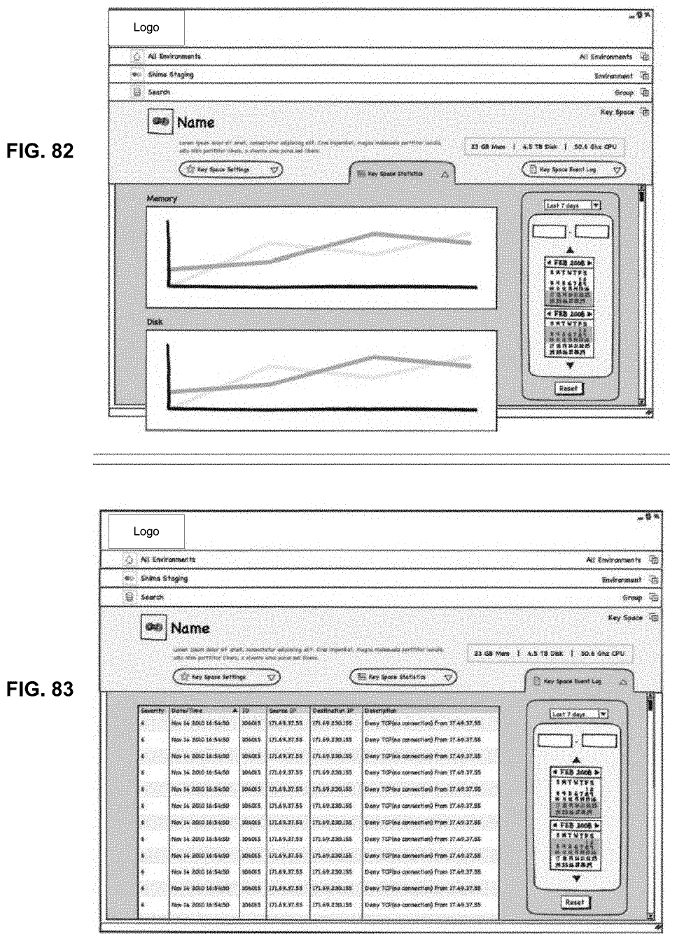

FIG. 82 shows statistics for the key space.

FIG. 83 shows an event log for the key space.

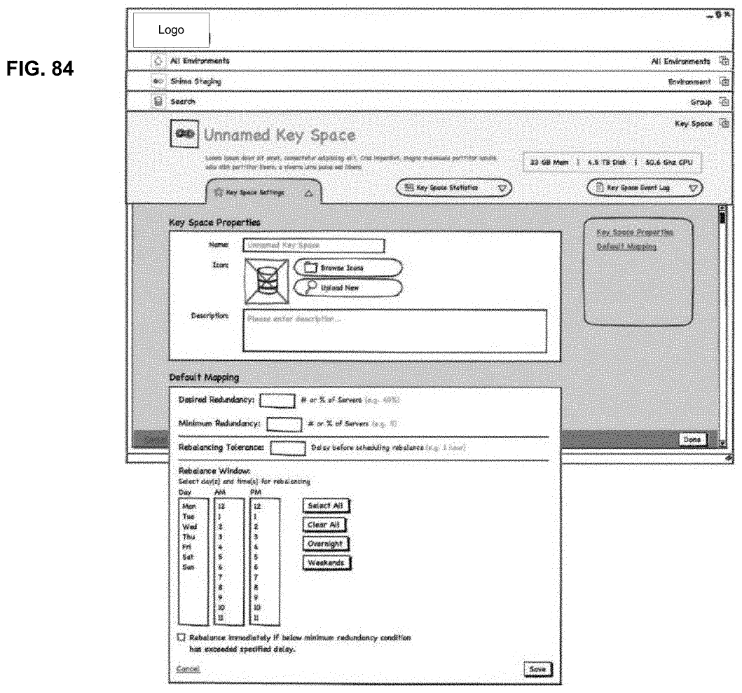

FIG. 84 shows settings for the key space.

In general, as shown in FIGS. 50-84, the administrator may configure the cloud system and administer multiple cloud systems through the same interface.

The foregoing description of implementations provides illustration and description, but is not intended to be exhaustive or to limit the invention to the precise form disclosed. Modifications and variations are possible in light of the above teachings or may be acquired from practice of the invention.

It will be apparent that exemplary aspects, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code, it being understood that software and control hardware could be designed to implement the aspects based on the description herein.

Further, certain portions of the invention may be implemented as “logic” that performs one or more functions. This logic may include hardware, such as an application specific integrated circuit or a field programmable gate array, or a combination of hardware and software.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

Accordingly, it is to be understood that the above description is intended to be illustrative and not restrictive. Many embodiments and applications other than the examples provided will be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

1. A distributed computing system comprising:
a plurality of instances of cloud elements connected by a network, each cloud element comprising:
a cloud service comprising:
a cartographer service providing mapping information for determining which of the plurality of instances of cloud elements may contain mapped data;
a cartographer proxy providing a communication interface for the cartographer service to communicate with the plurality of instances of cloud elements;
a registration service, providing information about the availability of the plurality of instances of cloud elements;
at least one local resource for manipulating the mapped data comprising:
a local service configured to manipulate the mapped data; and
a local proxy configured to provide a communication interface to the plurality of instances of cloud elements.

2. The distributed computing system of claim 1, wherein the cartographer service is configured to map a key derived from an aspect of the mapped data to at least one of the plurality of instances of cloud elements.

3. The distributed computing system of claim 2, wherein the cartographer proxy from a first instance of the plurality of instances of cloud elements communicates with the cartographer proxy of a second instance of the plurality of instances of cloud elements.

4. The distributed computing system of claim 1, wherein the registration service identifies each instance of the plurality of instances of cloud elements and their respective at least one local resource.

5. The distributed computing system of claim 1, wherein the at least one local resource provides a response to at least one of the plurality of instances of cloud elements after manipulating the mapped data.

6. The distributed computing system of claim 1, wherein the local service is configured to access local storage to access the mapped data.

7. The distributed computing system of claim 6, wherein the local proxy provides business logic for the local service.

8. The distributed computing system of claim 1, further comprising an access proxy substantially similar to the cartographer proxy, wherein the access proxy is configured to allow communication to the plurality of instances of cloud elements.

9. A distributed computing system comprising:
a plurality of cloud instances for processing data, the plurality of cloud instances connected by a network, each cloud instance comprising:
a cartographer for mapping said data to particular instances of the plurality of cloud instances; and
a registration service configured to transmit availability information about the instance and receive availability information about the other cloud instances;
at least one local resource configured to operate on the data.

10. The distributed computing system of claim 9, the cartographer further configured to map a key derived from a desired object included in the mapped data to at least one of the plurality of instances of cloud elements.

11. The distributed computing system of claim 10, wherein the key is derived from at least one of a unique identifier, a user name, and a file name.

12. The distributed computing system of claim 10, wherein the mapping provides a one to one relationship of the key to one of the plurality of instances of cloud elements.

13. The distributed computing system of claim 10, wherein the mapping provides a one to many relationship of the key to at least two of the plurality of instances of cloud elements.

14. The distributed computing system of claim 9, wherein the registration service tracks performance data of the plurality of cloud instances.

15. The distributed computing system of claim 9, the local service further comprising access to at least one of local RAM resources and local disk resources for storing the data.

16. A plurality of instances of cloud elements connected by a network, each cloud element comprising:
a cloud service comprising:
a cartographer service providing mapping information for determining which of the plurality of instances of cloud elements may contain mapped data;
a cartographer proxy providing a communication interface for the cartographer service to communicate with the plurality of instances of cloud elements;
a registration service, providing information about the availability of the plurality of instances of cloud elements;
a file service resource for retrieving and storing a file-mapped portion of the mapped data; and
a cache service resource for retrieving and storing a cache-mapped portion the mapped data.

17. The distributed computing system of claim 16, wherein the cartographer service uses the mapping information to determine which of the plurality of plurality of instances to communicate with at least one of the file service and the cache service.

18. The distributed computing system of claim 16, wherein the cartographer proxy of a first instance of the plurality of instances of cloud elements provides the availability of the file service and the cache service to the remaining instances of the plurality of instances of cloud elements.

19. The distributed computing system of claim 16, wherein the file service and the cache service operate in different namespaces relative to the cloud service.

20. The distributed computing system of claim 16, further comprising at least one of a file service proxy configured to provide a file service communication interface to the plurality of instances of cloud elements, and a cache service proxy configured to provide a cache service communication interface to the plurality of instances of cloud elements.
